(19) United States
(12) Patent Application Publication
(10) Pub. No.: US 2024/0111539 A1
(43) Pub. Date: Apr. 4, 2024

(54) DEVICE, METHOD AND SYSTEM TO DETERMINE A MODE OF PROCESSOR OPERATION BASED ON PAGE TABLE METADATA

(71) Applicant: Intel Corporation, Santa Clara, CA (US)

(72) Inventors: Jason Agron, San Jose, CA (US); Andreas Kleen, Portland, OR (US); Rangeen Basu Roy Chowdhury, Beaverton, OR (US)

(73) Assignee: Intel Corporation, Santa Clara, CA (US)

(21) Appl. No.: 17/957,969

(22) Filed: Sep. 30, 2022

(51) Int. Cl. G06F 9/38; G06F 9/30

(52) U.S. Cl. CPC G06F 9/3802; G06F 9/30189

(57) ABSTRACT

Techniques and mechanisms for a processor to determine an operational mode based on metadata for a page table. In an embodiment, an instruction fetch unit of the processor detects a pointer to a next instruction, in a sequence of instructions, which is to be prepared for execution with a core of the processor. Based on the pointer, a page table is identified as including an entry which indicates a location of the instruction. The page table includes, or otherwise corresponds to, metadata which comprises an identifier of an operational mode of the processor. Based on the metadata, the processor is transitioned to the operational mode in preparation for an execution of the instruction. In another embodiment, the operational mode is one of multiple operational modes which each correspond to a different instruction set architecture.

### BACKGROUND

### 1. Technical Field

This disclosure generally relates to computer processors and more particularly, but not exclusively, to the selection of an operational mode of a processor.

### 2. Background Art

An instruction set, or instruction set architecture (ISA), is the part of the computer architecture related to programming, including the native data types, instructions, register architecture, addressing modes, memory architecture, interrupt and exception handling, and external input and output (I/O). It should be noted that the term “instruction” generally refers herein to macro-instructions—that is instructions that are provided to the processor for execution—as opposed to micro-instructions or micro-ops—that is the result of a processor's decoder decoding macro-instructions. The micro-instructions or micro-ops can be configured to instruct an execution unit on the processor to perform operations to implement the logic associated with the macro-instruction.

The ISA is distinguished from the microarchitecture, which is the set of processor design techniques used to implement the instruction set. Processors with different microarchitectures can share a common instruction set. For example, Intel® Pentium 4 processors, Intel® Core™ processors, and processors from Advanced Micro Devices, Inc. of Sunnyvale Calif. implement nearly identical versions of the x86 instruction set (with some extensions that have been added with newer versions), but have different internal designs. For example, the same register architecture of the ISA may be implemented in different ways in different microarchitectures using well-known techniques, including dedicated physical registers, one or more dynamically allocated physical registers using a register renaming mechanism (e.g., the use of a Register Alias Table (RAT), a Reorder Buffer (ROB) and a retirement register file). Unless otherwise specified, the phrases register architecture, register file, and register are used herein to refer to that which is visible to the software/programmer and the manner in which instructions specify registers. Where a distinction is required, the adjective “logical,” “architectural,” or “software visible” will be used to indicate registers/files in the register architecture, while different adjectives will be used to designate registers in a given microarchitecture (e.g., physical register, reorder buffer, retirement register, register pool).

An instruction set includes one or more instruction formats. A given instruction format defines various fields (number of bits, location of bits) to specify, among other things, the operation to be performed and the operand(s) on which that operation is to be performed. Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. A given instruction is expressed using a given instruction format (and, if defined, in a given one of the instruction templates of that instruction format) and specifies the operation and the operands. An instruction stream is a specific sequence of instructions, where each instruction in the sequence is an occurrence of an instruction in an instruction format (and, if defined, a given one of the instruction templates of that instruction format).

### BRIEF DESCRIPTION OF THE DRAWINGS

The various embodiments of the present invention are illustrated by way of example, and not by way of limitation, in the figures of the accompanying drawings and in which:

FIG. 1 shows a functional block diagram illustrating features of a device to determine a mode of execution by a processor according to an embodiment.

FIG. 2 shows a flow diagram illustrating features of a method to configure an operational mode of a processor according to an embodiment.

FIG. 3 shows a functional block diagram illustrating features of a device to execute an instruction according to a mode which is determined based on page table metadata according to an embodiment.

FIG. 4 shows a functional block diagram illustrating features of a system to identify an operational mode with page table metadata according to an embodiment.

FIG. 5 shows a flow diagram illustrating features of a method to executing instructions each according to a respective processor mode according to an embodiment.

FIGS. 6A, 6B are format diagrams illustrating features of reference information which is accessed to determine an operational mode of a processor according to an embodiment.

FIG. 7 illustrates an exemplary system.

FIG. 8 illustrates a block diagram of an example processor that may have more than one core and an integrated memory controller.

FIG. 9A is a block diagram illustrating both an exemplary in-order pipeline and an exemplary register renaming, out-of-order issue/execution pipeline according to examples.

FIG. 9B is a block diagram illustrating both an exemplary example of an in-order architecture core and an exemplary register renaming, out-of-order issue/execution architecture core to be included in a processor according to examples.

FIG. 10 illustrates examples of execution unit(s) circuitry.

FIG. 11 is a block diagram of a register architecture according to some examples.

FIG. 12 illustrates examples of an instruction format.

FIG. 13 illustrates examples of an addressing field.

FIG. 14 illustrates examples of a first prefix.

FIGS. 15A-D illustrate examples of how the R, X, and B fields of the first prefix in FIG. 14 are used.

FIGS. 16A-B illustrate examples of a second prefix.

FIG. 17 illustrates examples of a third prefix.

FIG. 18 is a block diagram illustrating the use of a software instruction converter to convert binary instructions in a source instruction set architecture to binary instructions in a target instruction set architecture according to examples.

### DETAILED DESCRIPTION

Embodiments discussed herein variously provide techniques and mechanisms for determining an operational mode of a processor based on metadata for a page table. The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including a processor which supports multiple modes of instruction execution.

Some existing processors, e.g., in certain x86 architectures and in certain ARM architectures, are variously (re)configurable each to provide, at different times, any one of a respective plurality of operational modes. For example, there are instances wherein, over time, a given instruction set architecture (ISA) is subjected to “retrofitting” which provides additional features and/or alternative features, such as a style of encoding, one or more new instructions, changes to behavioral properties of a given instruction, or the like. In x86 processors (for example), ISA evolution has trended toward longer and longer encoding sequences because relatively dense coding sequences are more likely to be already occupied, and all new encodings must be legacy compliant. Even more unfortunate, sometimes the densest instructions encodings have relatively low usefulness for newer types of software.

To accommodate ISA modifications (for example), some existing processors support different modes of execution including a mode which enables execution of instructions for one ISA, and another mode which enables execution of instructions for another ISA, such as an updated version of the one ISA (or alternatively, an entirely different ISA).

Furthermore, some existing processors are capable of executing relatively “high-power” instructions, such as wide single instruction multiple data (SIMD) instructions, certain types of floating point instructions, and instructions which utilize hardware offload engines. These high-power instructions have a power, voltage and/or frequency penalty associated with their execution. This is typically because the high power or current draw of such instructions cannot always be sustained at the same frequency, current, and/or voltage levels as that required for lower-power instructions. To accommodate a power-efficient execution of various types of instructions (for example), some existing processors additionally or alternatively support different modes of execution including a mode which includes or otherwise corresponds to a first power performance profile for one or more high-power instructions, and another mode which includes or otherwise corresponds to a second power performance profile for one or more low-power instructions.

However, transitioning a processor between different operational modes has, to-date, required an explicit software control—e.g., wherein a software instruction has an opcode and/or parameter which the processor recognizes as an explicit identifier of a particular operational mode to be implemented. For example, in x86, mode switches usually involve explicit “long” branches or “long” calls to switch from 64-bit mode to 32-bit mode and vice versa. In ARM, mode switches for regular and Thumb modes use specialized instructions, or specialized branches that were able to switch modes. This reliance on explicit software controls for operational mode transitions is problematic when one or more types of processors—and/or legacy software, for example—do not know how to manage or otherwise operate with a given one or more modes. Also, the use of various mode switch instructions, under current techniques, cause problems which, for example, relate to tracking processor state with out of order execution, requiring a pipeline flush, or the like. As a result, conventional processor mode management techniques are usually difficult to extend, have higher overhead, are not speculation proof, and/or are not transparent (for example).

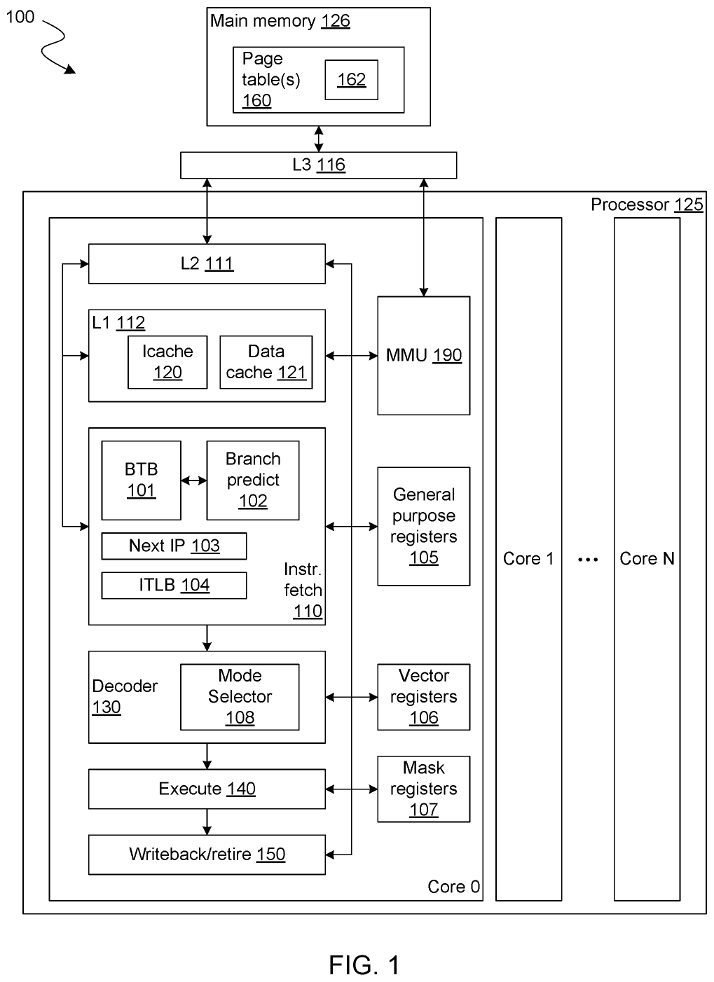

FIG. 1 shows features of a device 100 to determine a mode of execution by a processor according to an embodiment. Device 100 illustrates one example of an embodiment wherein a processor comprises circuitry to access metadata for a page table, wherein the accessing is based on a next instruction in an instruction sequence. The metadata is used to determine an operational mode which is to be a basis for the execution of the next instruction.

As shown in FIG. 1, device 100 comprises a processor 125 which (for example) includes a plurality of cores 0-N on which embodiments may be implemented. While only the details of a single core, Core 0, are shown, each of the other cores 1-N may include the same or a similar architecture as illustrated for Core 0. In other embodiments, processor 125 comprises only a single core.

In one embodiment, each core 0-N of the processor 125 includes a memory management unit 190 for performing memory operations such as load/store operations. In addition, each core 0-N includes a set of general purpose registers (GPRs) 105, a set of vector registers 106, and a set of mask registers 107. In one embodiment, multiple vector data elements are packed into each vector register 106 which may have a 512 bit width for storing two 256 bit values, four 128 bit values, eight 64 bit values, sixteen 32 bit values, etc. However, the underlying principles of some embodiments are not limited to any particular size/type of vector data. In one embodiment, the mask registers 107 include eight 64-bit operand mask registers used for performing bit masking operations on the values stored in the vector registers 106. However, the underlying principles of some embodiments are not limited to any particular mask register size/type. Furthermore, the illustrated connections between the components of Core 0 are merely illustrative, and other embodiments include more, fewer and/or different connections to variously facilitate signal communications within Core 0.

In one embodiment, each core may include a dedicated Level 1 (L1) cache 112 and Level 2 (L2) cache 111 for caching instructions and data according to a specified cache management policy. The L1 cache 112 includes a separate instruction cache 120 for storing instructions and a separate data cache 121 for storing data. The instructions and data stored within the various processor caches are managed at the granularity of cache lines which may be a fixed size (e.g., 64, 128, 512 Bytes in length). Each core of this exemplary embodiment has an instruction fetch unit 110 for fetching instructions from a main memory 126 and/or a shared Level 3 (L3) cache 116; a decode unit 130 for decoding the instructions (e.g., decoding program instructions into micro-operations or “micro-operations”); an execution unit 140 for executing the instructions; and a writeback unit 150 for retiring the instructions and writing back the results. In another embodiment, device 100 omits, but accommodates coupling to and operation with, main memory 126.

The instruction fetch unit 110 includes various well known components including a next instruction pointer (IP) 103 for storing the address of the next instruction to be fetched from memory 126 (or one of the caches); an instruction translation look-aside buffer (ITLB) 104 for storing a map of recently used virtual-to-physical instruction addresses to improve the speed of address translation; a branch prediction unit 102 for speculatively predicting instruction branch addresses; and branch target buffers (BTBs) 101 for storing branch addresses and target addresses. Once fetched, instructions are then streamed to the remaining stages of the instruction pipeline including the decode unit 130, the execution unit 140, and the writeback unit 150. Various structures and functions of each of these units are adapted from conventional processor architectures, in some embodiments. Such conventional processor structures and functions are well understood by those of ordinary skill in the art, and will not be described here in detail to avoid obscuring pertinent aspects of different embodiments.

In the illustrated embodiment, the decode unit 130 includes operational mode selector unit 108 to implement the techniques described herein for dynamically selecting between a plurality of operational modes. While illustrated within the decode unit 130 in FIG. 1, the operational mode selector 108 may be implemented within the execution unit 140 in an alternate embodiment (e.g., in the front end of the execution unit, prior to micro-operation execution). The underlying principles of some embodiments are not limited to any particular architectural location of the operational mode selector unit 108.

In an illustrative scenario according to one embodiment, a given operational mode of Core 0 comprises a mode of decoding (or “decode mode”) of decoder 130, and/or a mode of execution by execution unit 140. By way of illustration and not limitation, one decode mode supports one or more instructions which are not supported by another of decode mode. Additionally or alternatively, a given two decode modes support different respective encodings to represent the same instruction. Additionally or alternatively, a given two decode modes map the same instruction to the same micro-operations, to be executed with by execution unit 140 with the same micro-operation controls. In other embodiments, a given two decode modes map the same instruction to the same micro-operations, but are to be executed by execution unit 140 with different micro-operation controls—e.g., in different execution modes of execution unit 140. In still other embodiments, a given two decode modes map the same instruction to different respective micro-operations. In some embodiments, one of execution modes 341, . . . , 342 supports one or more micro-operation controls which are not supported in another of execution modes 341, . . . , 342.

To efficiently determine a mode of execution for a processor (such as processor 125), some embodiments variously provide, as metadata which is in—or otherwise corresponds to—a page table, an identifier of an operational mode which is to correspond to one or more instructions which are each associated with a respective entry of that page table. In response to an indication that one such instruction is a next instruction in a sequence of instructions, the metadata for the page table is accessed to determine which operational mode is identified by the metadata as corresponding to that instruction. Based on such accessing, the processor core in question is transitioned to the identified operational mode (if the core not already in said mode), and the instruction is subsequently executed based on said mode. In one such embodiment, the transition to the operational mode is performed independent of the instruction (or any other instruction in the sequence) explicitly identifying said operational mode. In some embodiments, the mode transition is relatively “lightweight,” as compared (for example) to one implemented, under existing techniques, by an explicit mode switch instruction. For example, the mode transition is performed with a multiplexer and/or any of various other types of circuitry which are suitable for selecting between different decoder circuits and/or between different execution circuits—e.g., without requiring a pipeline flush (for example) by the processor 125.

By way of illustration and not limitation, a core of processor 125 (such as Core 0) comprises circuitry which is operable to access some or all of the one or more page tables 160 based on an indication of a next instruction to be prepared for execution. In one such embodiment, circuitry of the instruction fetch unit 110 accesses ITLB 104 based on the next instruction pointer 103—e.g., wherein the circuitry performs a translation, search, or other suitable operation to identify a particular page table as including an entry which corresponds to the next instruction pointer 103.

In various embodiments, such accessing of one or more page tables 160 includes reading metadata 162 of the identified page table to determine an operational mode identifier which corresponds to the instruction indicated by the next instruction pointer 103. In one such embodiment, the operational mode selector unit 108 is coupled to receive or otherwise operate based on the operational mode identifier of metadata 162—e.g., wherein mode selector unit 108 transitions execution unit 140 (and/or other circuitry of Core 0) to the identified operational mode. Subsequently, the instruction indicated by the next instruction pointer 103 is executed while Core 0 is in the operational mode which is identified by metadata 162. In the example embodiment, the metadata 162 is in (and is descriptive of) a corresponding one of the one or more page tables 160. However, in other embodiments, metadata 162 is provided at a mode register or other suitable resource which is external to, but associated with, the corresponding page table.

In providing an operational mode identifier as metadata which is included in or otherwise associated with a page table (e.g., wherein the mode identifier is in addition to, or “overlays,” code pages for various ISAs), some embodiments variously allow code-type information to accompany a code stream for efficient use during instruction decode, for example. Some embodiments thus facilitate a transition between operational modes without requiring explicit management by software. Accordingly, said embodiments variously facilitate the introduction of new modal features that are fully compatible with legacy code (e.g., program, libraries, etc.) and that can be overlayed and imposed on legacy code, if desired.

In an embodiment, an operational mode identifier is accessed as page table metadata which a processor accesses as part of operations which (for example) are to fetch and interpret code bytes for consumption by a decoder. In an embodiment, this additional metadata accompanies (e.g., is descriptive of, but is distinguished from) the instruction bytes. Furthermore, this additional metadata informs the decoder circuitry and/or execution unit circuitry of any new rules or other properties regarding instruction decoding and semantics—e.g., without having to implement heavyweight, serializing, global modes within the processor pipeline.

In various embodiments, an operational mode identifier is provided as page table metadata to serve as a lightweight code-type annotation that (for example) is speculation resistant and/or transparent. For example, in various embodiments, a sequence of instructions includes instructions which variously correspond to different page tables that each include a respective operational mode identifier as metadata. During an execution of such a sequence of instructions, various operational mode identifiers are successively determined by accessing the different page tables, which allows one or more mode transitions to occur transparently and safely—e.g., without polluting a binary with explicit instructions for mode switching. This allows for potentially radical encoding and/or semantic changes to be made to a given ISA (for example), while maintaining transparent interoperability with legacy code.

In some embodiments, the mode transition is specific to circuitry of one core—e.g., wherein the respective operational modes of one or more other cores of the processor remain the same. For example, the transition changes a mode of instruction decoding by a decoder unit of the core, and/or changes a mode of instruction execution by an execution unit of the core. Additionally or alternatively, the mode transition changes a power performance characteristic of the processor—e.g., including a power performance characteristic of at least the processor core in question. In one such embodiment, a mode transition occurs independent of any need to flush an execution pipeline of the core.

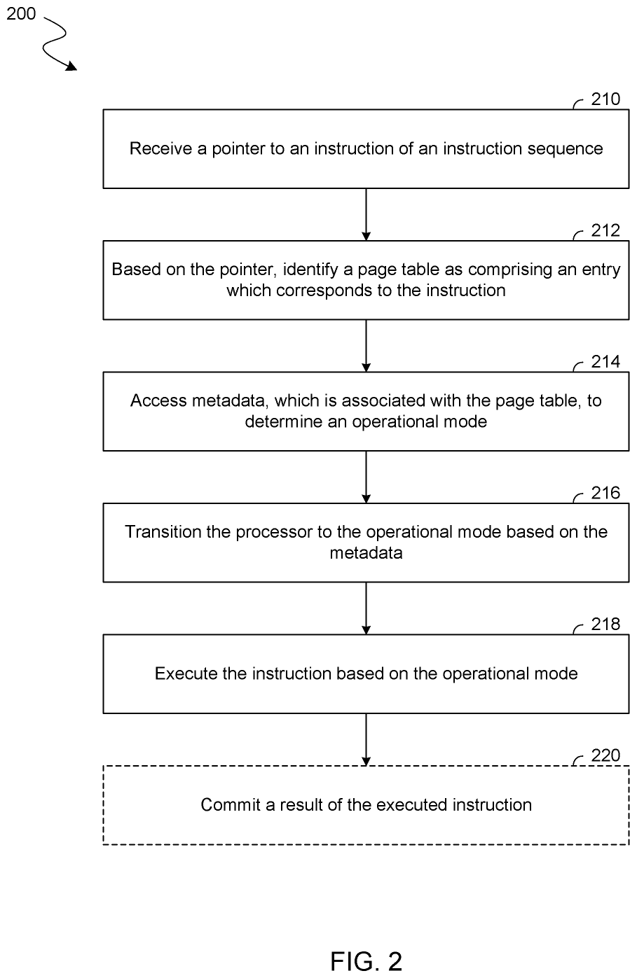

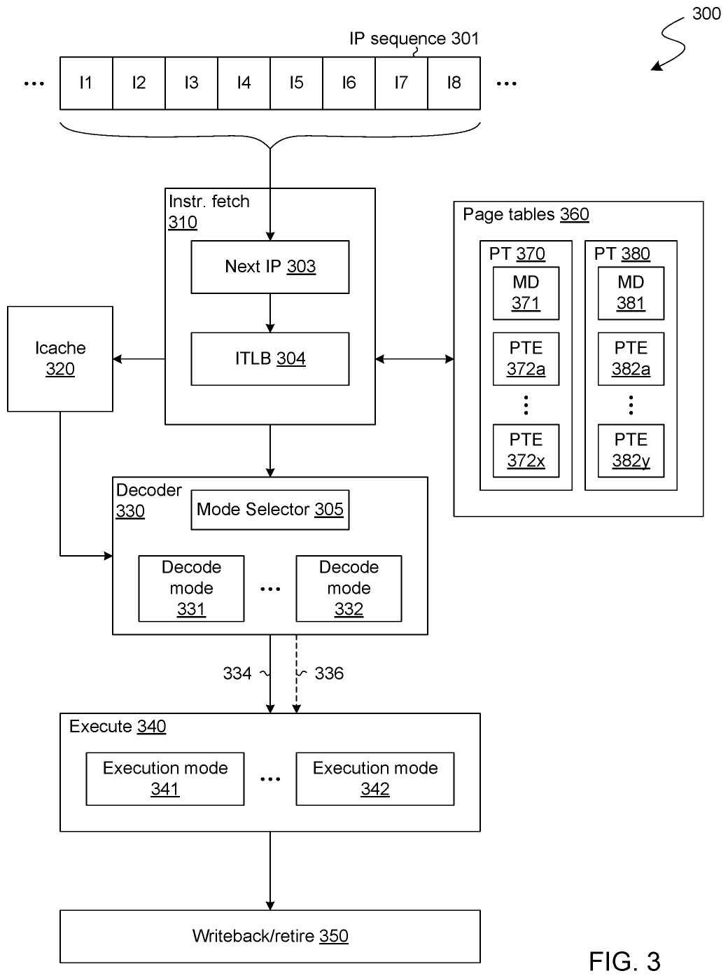

FIG. 2 shows features of a method 200, which is performed with a processor, to configure an operational mode of the processor according to an embodiment. The method 200 illustrates one example of an embodiment wherein a processor determines, based on metadata associated with a page table, whether (or not) at least one core of the processor is to be transitioned to a particular operational mode. Operations such as those of method 200 are performed, for example, with some or all of device 100. To illustrate certain features of various embodiments, method 200 is described herein with reference to operations by an example device 300 which is shown in FIG. 3. However, in other embodiments, one or more operations of method 200 are performed with any of various other suitable devices which provide functionality described herein.

As shown in FIG. 2, method 200 comprises (at 210) receiving a pointer to an instruction which is one of multiple instructions in a sequence of instructions which are to be executed with the processor. For example, FIG. 3 shows features of a device 300 to execute an instruction based on an operational mode which is determined based on page table metadata according to an embodiment. As shown in FIG. 3, a processor of device 300 comprises an instruction fetch unit 310, a decoder unit 330, an execution unit 340, and a writeback unit 350 which—for example—provide functionality such as that of instruction fetch unit 110, decode unit 130, execution unit 140, and writeback unit 150 (respectively). For example, an instruction cache 320, an ITLB 304 of instruction fetch unit 310, and a mode selector unit 305 of decoder unit 330 correspond functionally to instruction cache 120, ITLB 104, and mode selector unit 108 (respectively).

The processor is coupled to access page tables 360 which, for example, correspond functionally to the one or more page tables 160 of main memory 126. By way of illustration and not limitation, a first page table 370 comprises one or more page table entries (PTEs)—such as the illustrative PTEs 372a, . . . , 372x shown—which variously correspond each to a respective instruction or to respective data. The first page table 370 further comprises metadata (MD) 371 which includes an identifier of an operational mode that corresponds to some or all of the instructions which are indicated each by a respective one of PTEs 372a, . . . , 372x. Alternatively or in addition, a second page table 380 comprises one or more other PTEs—such as the illustrative PTEs 382a, . . . , 382y shown—which similarly correspond each to a respective instruction or to respective data. Page table 380 further comprises metadata (MD) 381 which includes an identifier of an operational mode that corresponds to some or all of the instructions which are indicated each by a respective one of PTEs 382a, . . . , 382y.

In one such embodiment, the receiving at 210 comprises instruction fetch unit 310 receiving or otherwise identifying a next IP 303 in an IP sequence 301—i.e., wherein IP sequence 301 is a sequence of instructions pointers which represents a corresponding sequence of instructions to be executed with the processor of device 300. The next IP 303 specifies or otherwise indicates to instruction fetch unit 310 a location of a next instruction which is to be decoded and/or otherwise prepared for execution with the processor.

Referring again to FIG. 2, method 200 further comprises (at 212) identifying a page table—based on the pointer received at 210—as comprising an entry which corresponds to the instruction. Based on the identifying at 212, method 200 (at 214) accesses metadata which is associated with (i.e., which is descriptive of and, in some embodiments, is included in) the page table to determine an operational mode of the processor. For example, in one illustrative embodiment, the identifying at 212 comprises instruction fetch unit 310 accessing page table 370 based on next IP 303—e.g., based on a determination that one of PTEs 372a, . . . , 372x comprises information indicating a location of the instruction to which next IP 303 points. In one such embodiment, such accessing includes or is otherwise based on a use of the next IP 303 to search ITLB 304—e.g., wherein the accessing includes operations adapted from conventional page table techniques. Based on a determination that a PTE of page table 370 (for example) corresponds to the instruction indicated by the next IP 303, instruction fetch unit 310 accesses the metadata MD 371 of that page table 370 to read or otherwise determine an identifier of an operational mode which corresponds to the instruction in question. Although metadata 371 is shown as being external to page table entries 372a, . . . , 372x, in other embodiments, an operational mode identifier is included in a PTE.

In an embodiment, page table metadata—e.g., MD 371 or MD 372—comprises a field which, for example, includes n bits (where n is a positive integer) to identify any of 2ⁿ possible operational modes. Additionally or alternatively, such page table metadata comprises a bitmap field including bits which each correspond to a different respective functionality. For each such bit of the bitmap field, a value of the bit specifies whether the corresponding functionality is to be enabled or disabled—e.g., wherein multiple operational modes each comprise a different respective combination of enablement states for the various functionalities.

Referring again to FIG. 2, method 200 further comprises (at 216) transitioning the processor to the operational mode based on the accessing of the metadata at 214. In some embodiments, the operational mode is that of merely one given core of the processor—e.g., wherein one or more other cores of the processor are each in a respective operational mode that is concurrent with and (for example) independent of the operational mode of that one given core. Accordingly, page table metadata in such embodiments variously facilitates a low overhead mechanism for indicating that a transient and/or non-global operational mode is to be implemented (for example) with one—e.g., only one—processor core. Such an indication is provided implicitly, in various embodiments—e.g., independent of the code stream in question and/or in a layered manner. In one such embodiment, a given page of code (based on metadata corresponding thereto) determines a mode of decoding by the one given core, which in turn affects other downstream operations of that core.

For example, the operational mode which is read from metadata 371, based on the next IP 303, is provided to a mode selector unit 305 of decoder unit 330. The mode selector unit 305 includes, has access to, or is otherwise coupled to operate based on, information which corresponds various operational mode identifiers each with a different respective one or more configurations of decoder 330 and/or a different respective one or more configurations of execution unit 340. By way of illustration and not limitation, a first configuration of decoder unit 330 implements a first decode mode 331, wherein a second configuration of decoder unit 330 implements a second decode mode 332. In some embodiments, decoder unit 330 is configurable to additionally or alternatively implement any of one or more other decode modes (not shown).

In an illustrative scenario according to one embodiment, decode mode 331 is to decode an instruction which is encoded according to a first instruction set architecture (ISA), wherein decode mode 332 is to decode an instruction which is encoded according to a second ISA. In one example embodiment, decode modes 331, 332 support different respective encodings for a given instruction, but (for example) each support a common mapping of that instruction to the same micro-operations—e.g., wherein execution semantics and/or assembly-level notations for executing the instruction are to be the same. In some embodiments, the transitioning at 216 comprises mode selector unit 305 selecting one of the decode modes 331, . . . , 332 over the others of the decode modes 331, . . . , 332—e.g., wherein such selection is based on MD 371 (or on other suitable metadata which is associated with page table PT 370).

Alternatively or in addition, a first configuration of execution unit 340 implements a first execution mode 341 of execution unit 340, wherein a second configuration of execution unit 340 implements a second execution mode 342 of execution unit 340. In some embodiments, execution unit 340 is configurable to additionally or alternatively implement any of one or more other execution modes (not shown).

In an illustrative scenario according to one embodiment, operational mode 341 is to implement executions based on a first ISA, wherein operational mode 342 is to implement executions based on a second ISA. In another embodiment, operational mode 341 is to provide a first level of a power performance parameter, wherein operational mode 342 is to provide a second level of the same power performance parameter. By way of illustration and not limitation, the power performance parameter comprises a supply voltage parameter, a clock frequency parameter, and/or the like. In still another embodiment, operational mode 341 is to enable one or more security features, wherein operational mode 342 is to disable the one or more security features—e.g., wherein the one or more security features comprise an access permission, a speculative execution control and/or the like. In some embodiments, the transitioning at 216 additionally or alternatively comprises mode selector unit 305 providing to execution unit 340 a control signal 336 to select one of the execution modes 341, . . . , 342 over the others of the execution modes 341, . . . , 342—e.g., wherein such selection is based on MD 371 (or on other suitable metadata which is associated with page table PT 370). In one such embodiment, decoder unit 330 provides a decoded instruction 334 which is to be executed with execution unit 340 based on the operational mode of the processor.

Referring again to FIG. 2, method 200 further comprises (at 218) executing the instruction based on the operational mode, and (at 220) committing a result of the executed instruction. In various embodiments, method 200 omits the committing at 220—e.g., wherein an execution of the instruction at 218 results in an error, fault or other such event.

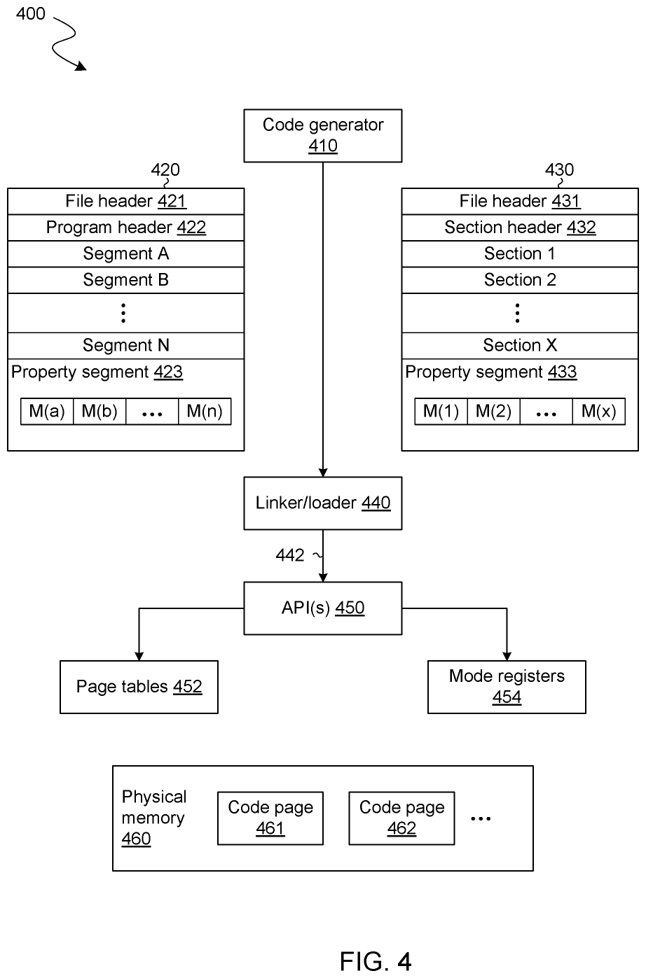

FIG. 4 shows features of a system 400 to identify an operational mode with page table metadata according to an embodiment. The system 400 illustrates one example of an embodiment wherein an output by code generation logic is used to determine that a page table is to provide metadata which identifies an operational mode as corresponding to one or more instructions in an instruction sequence. In various embodiments, system 400 facilitates functionality such as that of device 100 or method 200—e.g., wherein one or more operations of method 200 are performed based on information provided with system 400.

As shown in FIG. 4, system 400 comprises a code generator 410 (for example, including a compiler, an assembler and/or other suitable logic) which is to provide information which is used to determine the provisioning of metadata for a page table. In one such embodiment, code generator 410 generates a file 420 which, for example, is compatible with an Executable and Linkable Format (ELF). By way of illustration and not limitation, file 420 comprises both a file header 421, which identifies a format of file 420, and a program header 422 which specifies or otherwise indicates the respective offsets, sizes, permissions and/or other relevant information for one or more segments in file 420 (such as the illustrative Segments A, B, . . . , N shown). Program header 422, which is to be used for code execution, is provided to indicate to a kernel (or a runtime linker, for example) what is to be loaded into memory, a location of dynamic linking information, and/or the like.

In various embodiments, code generator 410 additionally or alternatively generates a file 430 which is also compatible with an ELF, for example. By way of illustration and not limitation, file 430 comprises a file header 431 which identifies a format of file 430, and further comprises a section header 432 which specifies or otherwise indicates the respective offsets, sizes and/or other relevant information for one or more sections in file 430 (such as the illustrative Sections 1, 2, . . . , X shown). In an embodiment, the one or more sections each comprise respective information which is used to link a target object file for building an executable.

To facilitate a provisioning of metadata which is associated with a page table (wherein the metadata comprises an operational mode identifier), code generator 410 provides property information which is included in, or with, file 420 and/or file 430. For example, in one such embodiment, property segment 423 of file 420 provides values M(a), M(b), . . . , M(n) which corresponds to segments A, B, . . . , N (respectively). For a given one of the values M(a), M(b), . . . , M(n), the value identifies a respective processor operational mode which is to be provided for any one or more instructions which are associated with the corresponding one of segments A, B, . . . , N. Alternatively or in addition, property segment 433 of file 430 provides values M(1), M(2), . . . , M(x) which corresponds to segments A, B, . . . , N (respectively). For a given one of the values M(1), M(2), . . . , M(x), the value identifies a respective processor operational mode which is to be provided for any one or more instructions which are associated with the corresponding one of sections 1, 2, . . . , X. In one such embodiment, at least two such operational modes each correspond to a different respective ISA—e.g., including two ISAs which are each defined or otherwise implemented with a respective one of the illustrative code pages 461, 462 in a physical memory 460.

In an illustrative embodiment, code generator 410 performs compiling, assembling and/or other suitable operations—based on input from a programmer—to generate one or each of files 420, 430, which are provided to a linker and loader 440 of system 400. The linker and loader 440 comprises any of various suitable combinations of hardware and/or executing software logic to perform linking operations based on the information from code generator 410, resulting in an output 442 which (for example) operates one or more application programming interfaces (APIs) 450 to load information which facilitates the execution of a sequence of instructions. In various embodiments, API(s) 450 include, for example, a mmap function of a Linux operating system (OS), a VirutalProtect function of a Windows OS, or the like.

In various embodiments, the API(s) 450 of system 400 are operated to variously place segments A, B, . . . , N into memory 460 at appropriate locations—e.g., with permissions and memory-types in accordance with application requirements. In one such embodiment, entries in page tables 452 are variously updated or otherwise accessed to indicate the respective locations of data and/or instructions in memory. Furthermore, mode registers 454 are accessed, in some embodiments, to facilitate the provisioning of metadata which is associated with a given one of page tables 452.

By way of illustration and not limitation, a given mode register is accessed to store operational mode identifiers based on some or all of the values M(a), M(b), . . . , M(n) and/or based on some or all of the values M(1), M(2), . . . , M(x). In one such embodiment, the operational mode identifiers are available in the mode registers 454 as metadata which is associated with page tables 452 (e.g., wherein each such operational mode identifier is metadata for any instructions represented in an entry of a corresponding page table). Additionally or alternatively, providing the operational mode identifiers in the mode registers 454 results in the operational mode identifiers being further provided each as metadata at a corresponding one of page tables 452 (e.g., whereby each such operational mode identifier is associated with any instruction which is represented in an entry of the corresponding page table).

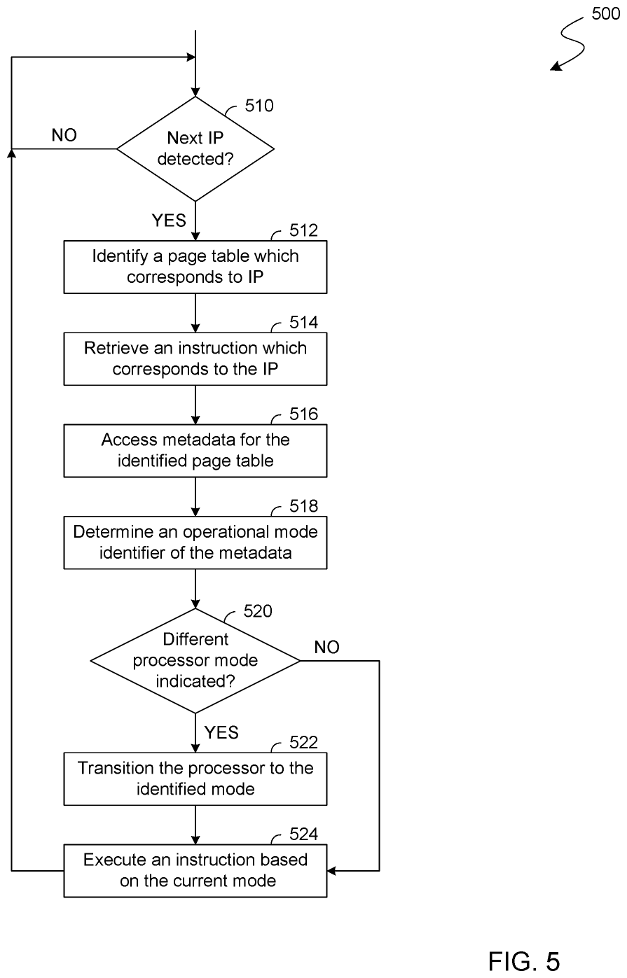

FIG. 5 shows features of a method 500 to executing instructions each based on a respective processor mode according to an embodiment. The method 500 illustrates one example of an embodiment wherein a processor performs multiple operational mode transitions each for a different respective one or more instructions of the same instruction sequence. Method 500 is performed, for example, with device 100, device 300, or system 400—e.g., wherein method 500 comprises operations of method 200.

As shown in FIG. 5, method 500 comprises performing an evaluation (at 510) to determine whether an instruction pointer (IP), for a next instruction of the instruction sequence, has been received or otherwise detected. For example, the evaluating at 510 is performed with instruction fetch unit 110 or instruction fetch unit 310, in various embodiments.

Where it is determined at 510 that a next IP has been detected, method 500 (at 512) performs a translation, ITLB lookup and/or any of various other suitable operations—based on the most recently detected IP—to identify a page table which corresponds to the IP. For example, the identifying comprises determining that the page table includes an entry which indicates a location from which the next instruction of the sequence is to be retrieved for decoding. Where it is instead determined at 510 that a next IP has yet to be detected, method 500 performs a next instance of the evaluating at 510 (e.g., until execution of the instruction sequence has completed, is interrupted, or otherwise ends).

After the page table is identified at 512, method 500 (at 514) retrieves the instruction which corresponds to—e.g., which is pointed to by—the IP which is most recently detected at 510. In some embodiments, the instruction is retrieved from an instruction cache (for example), or is retrieved from a location indicated by an entry of the corresponding page table.

Method 500 further comprises (at 516) accessing metadata for the page table which is most recently identified at 512, and (at 518) determining an operational mode identifier of the accessed metadata. For example, the accessing at 516 comprises reading an identifier of an operational mode of the processor—e.g., wherein the metadata defines or otherwise indicates a correspondence of the identified operational mode with any instructions which are represented by some or all entries of the page table. The metadata thus serves as an indication that execution of any such instructions is to be based on the identified operational mode.

Method 500 further comprises performing an evaluation (at 520) to determine, based on the operational mode determined at 518, whether the processor has to be transitioned from a current operational mode—i.e., including determining whether (or not) the processor is currently in the operational mode which is identified by the metadata accessed at 516. Where it is determined at 520 that a mode transition of the processor is indicated, method 500 (at 522) configures a decoder unit, an execution unit (execution unit 140 or execution unit 340, for example) and/or other suitable circuitry of the processor to transition the processor from one operational mode to the different operational mode which is determined at 518. In an embodiment, the operational mode is specific to one core of the processor (e.g., wherein the mode is concurrent with, and independent of, the currently configured operational mode of any other core of the processor). Subsequently (at 524), method 500 executes the instruction based on the currently configured operational mode.

Where it is instead determined at 520 that no operational mode transition of the processor is indicated, method 500 simply performs the executing at 524—i.e., without any operational mode transition such as that which is performed at 522. After the executing of the instruction at 524, method 500 performs a next instance of the evaluating at 510—e.g., to facilitate providing a suitable operational mode for a next instruction of the instruction sequence.

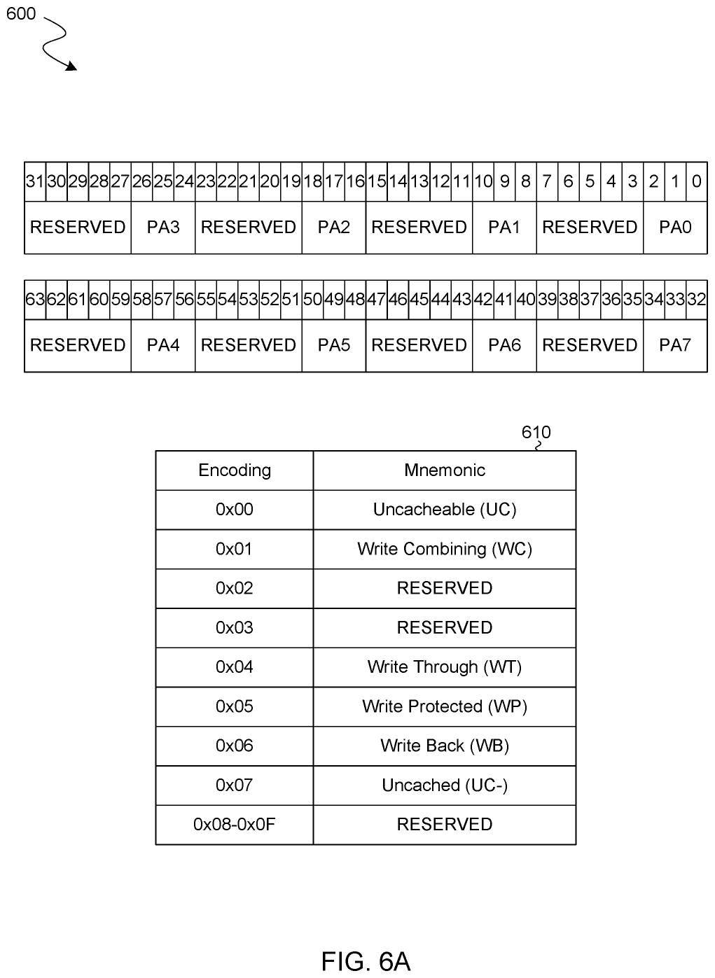

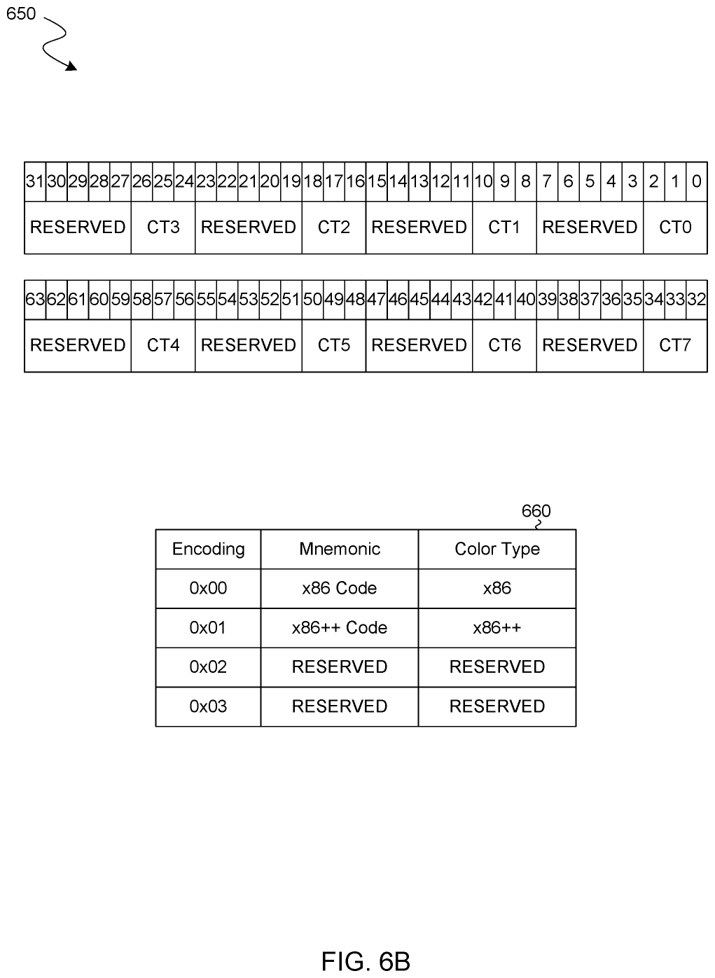

FIGS. 6A, 6B show respective mode registers 600, 650 which are to variously provide reference information for use in determining an operational mode of a processor according to an embodiment. In various embodiments, mode registers 600, 650 are provided at a processor of device 100, device 300, or system 400—e.g., wherein one or more operations of method 200 or method 500 are performed based on mode registers 600, 650.

As shown in FIG. 6A, the illustrative 64-bit mode register 600 comprises eight page attribute (PAT) fields PAT0 through PAT7 which are variously available each to be programmed to configure a respective page table. For a given one of the fields PAT0 through PAT7, the field is available to receive a value which, according to an encoding scheme such as that illustrated in table 610, identifies a particular memory type which is to be used for implementing the corresponding page table. By way of illustration and not limitation, mode register 600 has features such as those of the IA32_PAT mode set register which is in various x86 processor architectures from Intel Corporation of Santa Clara, CA.

As shown in FIG. 6A, the illustrative 64-bit mode register 650 comprises eight code attribute table (CAT) fields CT0 through CT7 which each correspond (for example) to a respective one of fields PAT0 through PAT7 (or otherwise correspond each to a respective one or more page tables). For a given one of fields CT0 through CT7, the field is available be programmed to identify an operational mode which is to be associated with the corresponding one or more page tables. For example, a given one of the fields CT0 through CT7 receives a value which, according to an encoding scheme such as that illustrated in table 660, identifies a particular operational mode which is to be associated with a given page table (and, for example, with one or more instructions—if any—which are represented in the page table).

In an illustrative scenario according to one embodiment, the respective fields PAT0 and CT0 of mode registers 600, 650 each correspond to a first page table. The field PAT0 is programmed with a value which indicates a first memory type to be used for implementing the first page table. Furthermore, the field CT0 is programmed with a value which identifies a first operational mode as corresponding to some or all entries of the first page table. More particularly, the value of field CT0 indicates that, for one or more instructions (if any) which are represented each by a respective entry of the first page table, execution of the instruction with a given core of the processor is to take place while that core in the first operational mode. In one such embodiment, the field CT0 (or other metadata which describes entries of the first page table) is accessed based on a determination that an entry in the first page table includes information regarding a next instruction in an instruction sequence which is being executed with the processor. Based on such accessing, the processor is transitioned to the first operational mode (if it is not already in that first operational mode), and the instruction in question is subsequently executed based on said first operational mode.

Additionally or alternatively, the respective fields PAT1 and CT1 of mode registers 600, 650 each correspond to a second page table. The field PAT1 is programmed with a value which indicates a second memory type to be used for implementing the second page table—e.g., wherein the field CT1 is programmed with a value which identifies a second operational mode as corresponding to some or all entries of the second page table. In one such embodiment, the field CT1 (or other metadata which describes entries of the second page table) is accessed based on a determination that an entry in the second page table includes information regarding a different next instruction in the instruction sequence. Based on such accessing, the processor is transitioned to the second operational mode (if it is not already in that second operational mode), and the instruction in question is subsequently executed based on said second operational mode.

In a similar way, fields PAT2 and CT2 each correspond to a third page table, fields PAT3 and CT3 each correspond to a fourth page table, and the like. As a result, some embodiments provide mode registers 600, 650 to variously associate page tables (and instructions variously represented by entries of said page tables) each with a respective one of multiple available operational modes of the processor.

In the illustrative embodiment shown, the encoding scheme shown in table 660 enables an identification of a first operational mode which is to enable execution of an instruction in a first ISA (identified with the illustrative type label “x86”). Furthermore, the encoding scheme enables the additional or alternative identification of a second operational mode which is instead to enable execution of an instruction in a second ISA (identified with the illustrative type label “x86++”).

In various embodiments, an encoding such as that illustrated by table 660 enables a given one of fields CT0 through CT7 to be used for identifying any of multiple operational modes which each support a different respective ISA. In one such embodiment, a first operational mode supports a first ISA, wherein a second operational mode supports a second ISA which (for example) is an updated or otherwise modified version of the first ISA. By way of illustration and not limitation, the second ISA includes additional encodings which are not available in the first ISA (e.g., including encodings for new instructions not supported by the first ISA). Alternatively or in addition, the second ISA includes a modified version of one or more encodings of the first ISA, and/or deprecates or repurposes one or more other encodings of the first ISA (e.g., for instructions which are no longer legal).

In some embodiments, the multiple operational modes additionally or alternatively include a mode which supports one type of instruction execution for a given ISA, and another mode which supports an alternative type of instruction execution for that same ISA. Such modes implement different respective timing features, power performance features, security based features and/or the like, but share the instruction semantics (for example) of the same ISA. In one such embodiment, a mode provides relatively enhanced security (as compared to another mode) by disabling or otherwise restricting one or more micro-architectural optimizations—e.g., in order to prevent side channel observations of the executing code.

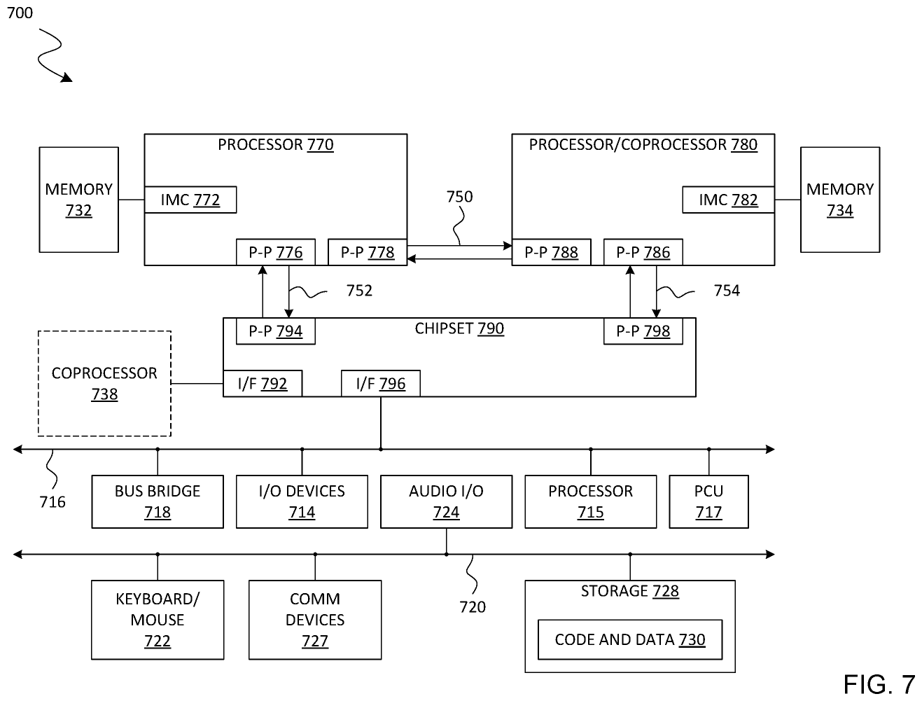

FIG. 7 illustrates an exemplary system. Multiprocessor system 700 is a point-to-point interconnect system and includes a plurality of processors including a first processor 770 and a second processor 780 coupled via a point-to-point interconnect 750. In some examples, the first processor 770 and the second processor 780 are homogeneous. In some examples, first processor 770 and the second processor 780 are heterogenous. Though the exemplary system 700 is shown to have two processors, the system may have three or more processors, or may be a single processor system.

Processors 770 and 780 are shown including integrated memory controller (IMC) circuitry 772 and 782, respectively. Processor 770 also includes as part of its interconnect controller point-to-point (P-P) interfaces 776 and 778; similarly, second processor 780 includes P-P interfaces 786 and 788. Processors 770, 780 may exchange information via the point-to-point (P-P) interconnect 750 using P-P interface circuits 778, 788. IMCs 772 and 782 couple the processors 770, 780 to respective memories, namely a memory 732 and a memory 734, which may be portions of main memory locally attached to the respective processors.

Processors 770, 780 may each exchange information with a chipset 790 via individual P-P interconnects 752, 754 using point to point interface circuits 776, 794, 786, 798. Chipset 790 may optionally exchange information with a coprocessor 738 via an interface 792. In some examples, the coprocessor 738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 770, 780 or outside of both processors, yet connected with the processors via P-P interconnect, such that either or both processors' local cache information may be stored in the shared cache if a processor is placed into a low power mode.

Chipset 790 may be coupled to a first interconnect 716 via an interface 796. In some examples, first interconnect 716 may be a Peripheral Component Interconnect (PCI) interconnect, or an interconnect such as a PCI Express interconnect or another I/O interconnect. In some examples, one of the interconnects couples to a power control unit (PCU) 717, which may include circuitry, software, and/or firmware to perform power management operations with regard to the processors 770, 780 and/or co-processor 738. PCU 717 provides control information to a voltage regulator (not shown) to cause the voltage regulator to generate the appropriate regulated voltage. PCU 717 also provides control information to control the operating voltage generated. In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. In yet other examples, power management operations to be performed by PCU 717 may be implemented externally to a processor, such as by way of a separate power management integrated circuit (PMIC) or another component external to the processor. In yet other examples, power management operations to be performed by PCU 717 may be implemented within BIOS or other system software.

Various I/O devices 714 may be coupled to first interconnect 716, along with a bus bridge 718 which couples first interconnect 716 to a second interconnect 720. In some examples, one or more additional processor(s) 715, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 716. In some examples, second interconnect 720 may be a low pin count (LPC) interconnect. Various devices may be coupled to second interconnect 720 including, for example, a keyboard and/or mouse 722, communication devices 727 and a storage circuitry 728. Storage circuitry 728 may be one or more non-transitory machine-readable storage media as described below, such as a disk drive or other mass storage device which may include instructions/code and data 730 in some examples. Further, an audio I/O 724 may be coupled to second interconnect 720. Note that other architectures than the point-to-point architecture described above are possible. For example, instead of the point-to-point architecture, a system such as multiprocessor system 700 may implement a multi-drop interconnect or other such architecture.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

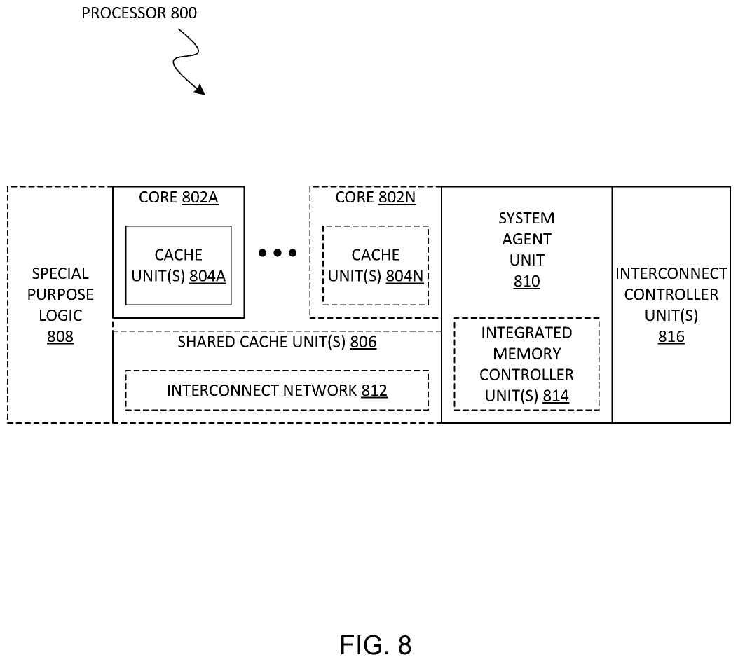

FIG. 8 illustrates a block diagram of an example processor 800 that may have more than one core and an integrated memory controller. The solid lined boxes illustrate a processor 800 with a single core 802A, a system agent unit circuitry 810, a set of one or more interconnect controller unit(s) circuitry 816, while the optional addition of the dashed lined boxes illustrates an alternative processor 800 with multiple cores 802A-N, a set of one or more integrated memory controller unit(s) circuitry 814 in the system agent unit circuitry 810, and special purpose logic 808, as well as a set of one or more interconnect controller units circuitry 816. Note that the processor 800 may be one of the processors 770 or 780, or co-processor 738 or 715 of FIG. 7.

Thus, different implementations of the processor 800 may include: 1) a CPU with the special purpose logic 808 being integrated graphics and/or scientific (throughput) logic (which may include one or more cores, not shown), and the cores 802A-N being one or more general purpose cores (e.g., general purpose in-order cores, general purpose out-of-order cores, or a combination of the two); 2) a coprocessor with the cores 802A-N being a large number of special purpose cores intended primarily for graphics and/or scientific (throughput); and 3) a coprocessor with the cores 802A-N being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 804A-N within the cores 802A-N, a set of one or more shared cache unit(s) circuitry 806, and external memory (not shown) coupled to the set of integrated memory controller unit(s) circuitry 814. The set of one or more shared cache unit(s) circuitry 806 may include one or more mid-level caches, such as level 2 (L2), level 3 (L3), level 4 (L4), or other levels of cache, such as a last level cache (LLC), and/or combinations thereof. While in some examples ring-based interconnect network circuitry 812 interconnects the special purpose logic 808 (e.g., integrated graphics logic), the set of shared cache unit(s) circuitry 806, and the system agent unit circuitry 810, alternative examples use any number of well-known techniques for interconnecting such units. In some examples, coherency is maintained between one or more of the shared cache unit(s) circuitry 806 and cores 802A-N.

In some examples, one or more of the cores 802A-N are capable of multi-threading. The system agent unit circuitry 810 includes those components coordinating and operating cores 802A-N. The system agent unit circuitry 810 may include, for example, power control unit (PCU) circuitry and/or display unit circuitry (not shown). The PCU may be or may include logic and components needed for regulating the power state of the cores 802A-N and/or the special purpose logic 808 (e.g., integrated graphics logic). The display unit circuitry is for driving one or more externally connected displays.

The cores 802A-N may be homogenous in terms of instruction set architecture (ISA). Alternatively, the cores 802A-N may be heterogeneous in terms of ISA; that is, a subset of the cores 802A-N may be capable of executing an ISA, while other cores may be capable of executing only a subset of that ISA or another ISA.

### Exemplary Core Architectures—In-Order and Out-of-Order Core Block Diagram

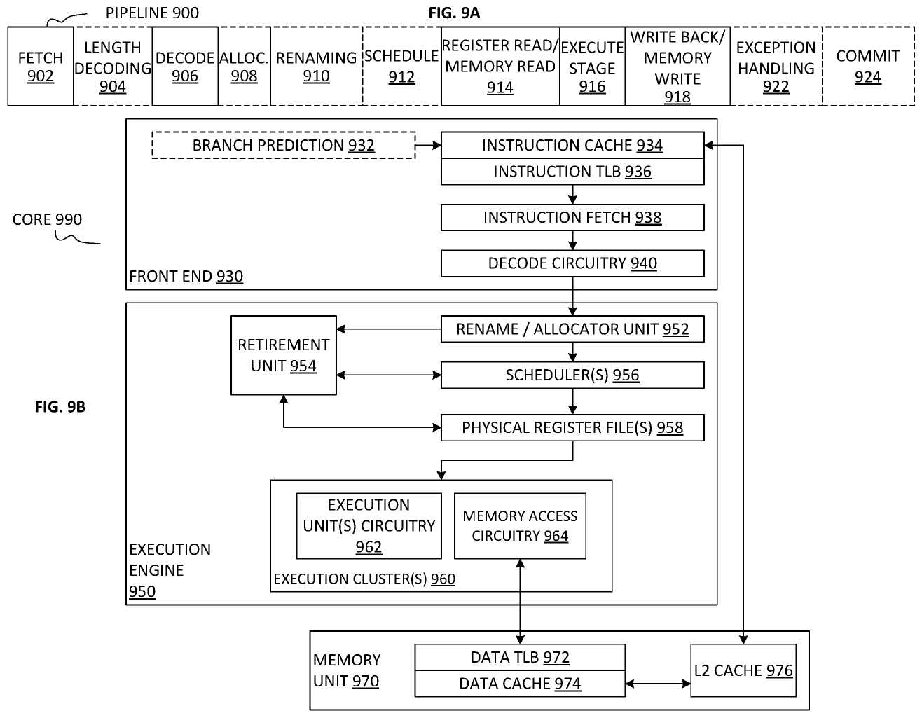

FIG. 9A is a block diagram illustrating both an exemplary in-order pipeline and an exemplary register renaming, out-of-order issue/execution pipeline according to examples. FIG. 9B is a block diagram illustrating both an exemplary example of an in-order architecture core and an exemplary register renaming, out-of-order issue/execution architecture core to be included in a processor according to examples. The solid lined boxes in FIGS. 9A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 9A, a processor pipeline 900 includes a fetch stage 902, an optional length decoding stage 904, a decode stage 906, an optional allocation (Alloc) stage 908, an optional renaming stage 910, a schedule (also known as a dispatch or issue) stage 912, an optional register read/memory read stage 914, an execute stage 916, a write back/memory write stage 918, an optional exception handling stage 922, and an optional commit stage 924. One or more operations can be performed in each of these processor pipeline stages. For example, during the fetch stage 902, one or more instructions are fetched from instruction memory, and during the decode stage 906, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 906 and the register read/memory read stage 914 may be combined into one pipeline stage. In one example, during the execute stage 916, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 9B may implement the pipeline 900 as follows: 1) the instruction fetch circuitry 938 performs the fetch and length decoding stages 902 and 904; 2) the decode circuitry 940 performs the decode stage 906; 3) the rename/allocator unit circuitry 952 performs the allocation stage 908 and renaming stage 910; 4) the scheduler(s) circuitry 956 performs the schedule stage 912; 5) the physical register file(s) circuitry 958 and the memory unit circuitry 970 perform the register read/memory read stage 914; the execution cluster(s) 960 perform the execute stage 916; 6) the memory unit circuitry 970 and the physical register file(s) circuitry 958 perform the write back/memory write stage 918; 7) various circuitry may be involved in the exception handling stage 922; and 8) the retirement unit circuitry 954 and the physical register file(s) circuitry 958 perform the commit stage 924.

FIG. 9B shows a processor core 990 including front-end unit circuitry 930 coupled to an execution engine unit circuitry 950, and both are coupled to a memory unit circuitry 970. The core 990 may be a reduced instruction set architecture computing (RISC) core, a complex instruction set architecture computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front end unit circuitry 930 may include branch prediction circuitry 932 coupled to an instruction cache circuitry 934, which is coupled to an instruction translation lookaside buffer (TLB) 936, which is coupled to instruction fetch circuitry 938, which is coupled to decode circuitry 940. In one example, the instruction cache circuitry 934 is included in the memory unit circuitry 970 rather than the front-end circuitry 930. The decode circuitry 940 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 940 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 940 may be implemented using various different mechanisms. Examples of suitable mechanisms include, but are not limited to, look-up tables, hardware implementations, programmable logic arrays (PLAs), microcode read only memories (ROMs), etc. In one example, the core 990 includes a microcode ROM (not shown) or other medium that stores microcode for certain macroinstructions (e.g., in decode circuitry 940 or otherwise within the front end circuitry 930). In one example, the decode circuitry 940 includes a micro-operation (micro-op) or operation cache (not shown) to hold/cache decoded operations, micro-tags, or micro-operations generated during the decode or other stages of the processor pipeline 900. The decode circuitry 940 may be coupled to rename/allocator unit circuitry 952 in the execution engine circuitry 950.

The execution engine circuitry 950 includes the rename/allocator unit circuitry 952 coupled to a retirement unit circuitry 954 and a set of one or more scheduler(s) circuitry 956. The scheduler(s) circuitry 956 represents any number of different schedulers, including reservations stations, central instruction window, etc. In some examples, the scheduler(s) circuitry 956 can include arithmetic logic unit (ALU) scheduler/scheduling circuitry, ALU queues, arithmetic generation unit (AGU) scheduler/scheduling circuitry, AGU queues, etc. The scheduler(s) circuitry 956 is coupled to the physical register file(s) circuitry 958. Each of the physical register file(s) circuitry 958 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 958 includes vector registers unit circuitry, writemask registers unit circuitry, and scalar register unit circuitry. These register units may provide architectural vector registers, vector mask registers, general-purpose registers, etc. The physical register file(s) circuitry 958 is coupled to the retirement unit circuitry 954 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 954 and the physical register file(s) circuitry 958 are coupled to the execution cluster(s) 960. The execution cluster(s) 960 includes a set of one or more execution unit(s) circuitry 962 and a set of one or more memory access circuitry 964. The execution unit(s) circuitry 962 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 956, physical register file(s) circuitry 958, and execution cluster(s) 960 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 964). It should also be understood that where separate pipelines are used, one or more of these pipelines may be out-of-order issue/execution and the rest in-order.

In some examples, the execution engine unit circuitry 950 may perform load store unit (LSU) address/data pipelining to an Advanced Microcontroller Bus (AMB) interface (not shown), and address phase and writeback, data phase load, store, and branches.

The set of memory access circuitry 964 is coupled to the memory unit circuitry 970, which includes data TLB circuitry 972 coupled to a data cache circuitry 974 coupled to a level 2 (L2) cache circuitry 976. In one exemplary example, the memory access circuitry 964 may include a load unit circuitry, a store address unit circuit, and a store data unit circuitry, each of which is coupled to the data TLB circuitry 972 in the memory unit circuitry 970. The instruction cache circuitry 934 is further coupled to the level 2 (L2) cache circuitry 976 in the memory unit circuitry 970. In one example, the instruction cache 934 and the data cache 974 are combined into a single instruction and data cache (not shown) in L2 cache circuitry 976, a level 3 (L3) cache circuitry (not shown), and/or main memory. The L2 cache circuitry 976 is coupled to one or more other levels of cache and eventually to a main memory.

The core 990 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 990 includes logic to support a packed data instruction set architecture extension (e.g., AVX1, AVX2), thereby allowing the operations used by many multimedia applications to be performed using packed data.

### Exemplary Execution Unit(s) Circuitry

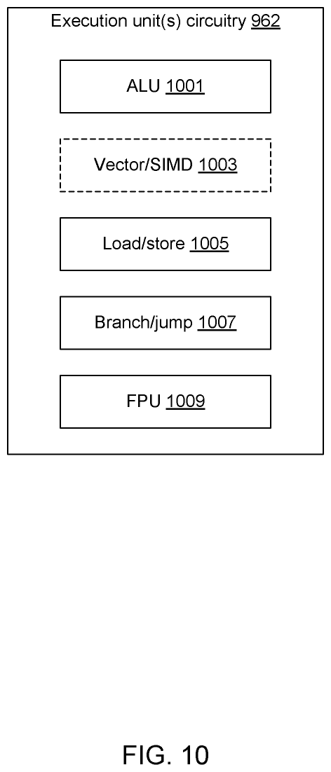

FIG. 10 illustrates examples of execution unit(s) circuitry, such as execution unit(s) circuitry 962 of FIG. 9B. As illustrated, execution unit(s) circuitry 962 may include one or more ALU circuits 1001, optional vector/single instruction multiple data (SIMD) circuits 1003, load/store circuits 1005, branch/jump circuits 1007, and/or Floating-point unit (FPU) circuits 1009. ALU circuits 1001 perform integer arithmetic and/or Boolean operations. Vector/SIMD circuits 1003 perform vector/SIMD operations on packed data (such as SIMD/vector registers). Load/store circuits 1005 execute load and store instructions to load data from memory into registers or store from registers to memory. Load/store circuits 1005 may also generate addresses. Branch/jump circuits 1007 cause a branch or jump to a memory address depending on the instruction. FPU circuits 1009 perform floating-point arithmetic. The width of the execution unit(s) circuitry 962 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Exemplary Register Architecture

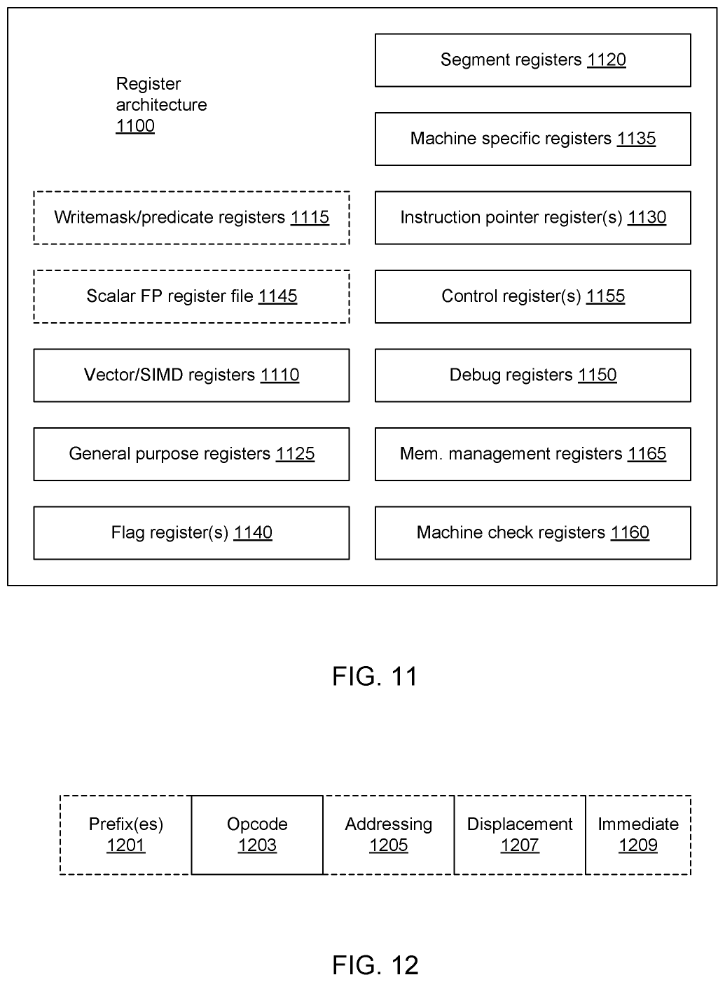

FIG. 11 is a block diagram of a register architecture 1100 according to some examples. As illustrated, the register architecture 1100 includes vector/SIMD registers 1110 that vary from 128-bit to 1,024 bits width. In some examples, the vector/SIMD registers 1110 are physically 512-bits and, depending upon the mapping, only some of the lower bits are used. For example, in some examples, the vector/SIMD registers 1110 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1100 includes writemask/predicate registers 1115. For example, in some examples, there are 8 writemask/predicate registers (sometimes called k0 through k7) that are each 16-bit, 32-bit, 64-bit, or 128-bit in size. Writemask/predicate registers 1115 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1115 corresponds to a data element position of the destination. In other examples, the writemask/predicate registers 1115 are scalable and consists of a set number of enable bits for a given vector element (e.g., 8 enable bits per 64-bit vector element).

The register architecture 1100 includes a plurality of general-purpose registers 1125. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1100 includes scalar floating-point (FP) register 1145 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1140 (e.g., EFLAGS, RFLAGS, etc.) store status and control information for arithmetic, compare, and system operations. For example, the one or more flag registers 1140 may store condition code information such as carry, parity, auxiliary carry, zero, sign, and overflow. In some examples, the one or more flag registers 1140 are called program status and control registers.

Segment registers 1120 contain segment points for use in accessing memory. In some examples, these registers are referenced by the names CS, DS, SS, ES, FS, and GS.

Machine specific registers (MSRs) 1135 control and report on processor performance. Most MSRs 1135 handle system-related functions and are not accessible to an application program. Machine check registers 1160 consist of control, status, and error reporting MSRs that are used to detect and report on hardware errors.

One or more instruction pointer register(s) 1130 store an instruction pointer value. Control register(s) 1155 (e.g., CR0-CR4) determine the operating mode of a processor (e.g., processor 770, 780, 738, 715, and/or 800) and the characteristics of a currently executing task. Debug registers 1150 control and allow for the monitoring of a processor or core's debugging operations.

Memory (mem) management registers 1165 specify the locations of data structures used in protected mode memory management. These registers may include a GDTR, IDRT, task register, and a LDTR register.

Alternative examples may use wider or narrower registers. Additionally, alternative examples may use more, less, or different register files and registers. The register architecture 1100 may, for example, be used in physical register file(s) circuitry 9 58.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Exemplary Instruction Formats.

Examples of the instruction(s) described herein may be embodied in different formats. Additionally, exemplary systems, architectures, and pipelines are detailed below. Examples of the instruction(s) may be executed on such systems, architectures, and pipelines, but are not limited to those detailed.

FIG. 12 illustrates examples of an instruction format. As illustrated, an instruction may include multiple components including, but not limited to, one or more fields for: one or more prefixes 1201, an opcode 1203, addressing information 1205 (e.g., register identifiers, memory addressing information, etc.), a displacement value 1207, and/or an immediate value 1209. Note that some instructions utilize some or all of the fields of the format whereas others may only use the field for the opcode 1203. In some examples, the order illustrated is the order in which these fields are to be encoded, however, it should be appreciated that in other examples these fields may be encoded in a different order, combined, etc.

The prefix(es) field(s) 1201, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1203 is used to at least partially define the operation to be performed upon a decoding of the instruction. In some examples, a primary opcode encoded in the opcode field 1203 is one, two, or three bytes in length. In other examples, a primary opcode can be a different length. An additional 3-bit opcode field is sometimes encoded in another field.

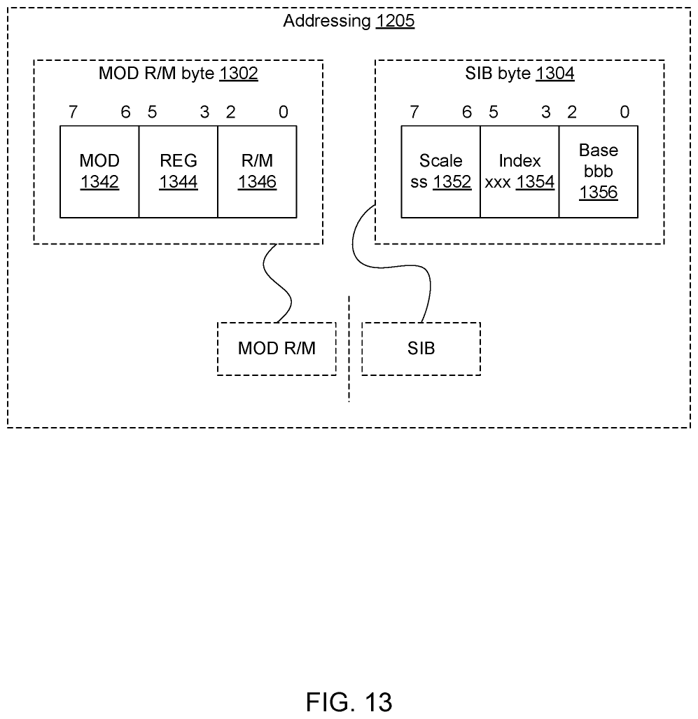

The addressing field 1205 is used to address one or more operands of the instruction, such as a location in memory or one or more registers. FIG. 13 illustrates examples of the addressing field 1205. In this illustration, an optional ModR/M byte 1302 and an optional Scale, Index, Base (SIB) byte 1304 are shown. The ModR/M byte 1302 and the SIB byte 1304 are used to encode up to two operands of an instruction, each of which is a direct register or effective memory address. Note that each of these fields are optional in that not all instructions include one or more of these fields. The MOD R/M byte 1302 includes a MOD field 1342, a register (reg) field 1344, and R/M field 1346.

The content of the MOD field 1342 distinguishes between memory access and non-memory access modes. In some examples, when the MOD field 1342 has a binary value of 11 (11b), a register-direct addressing mode is utilized, and otherwise register-indirect addressing is used.

The register field 1344 may encode either the destination register operand or a source register operand, or may encode an opcode extension and not be used to encode any instruction operand. The content of register index field 1344, directly or through address generation, specifies the locations of a source or destination operand (either in a register or in memory). In some examples, the register field 1344 is supplemented with an additional bit from a prefix (e.g., prefix 1201) to allow for greater addressing.

The R/M field 1346 may be used to encode an instruction operand that references a memory address or may be used to encode either the destination register operand or a source register operand. Note the R/M field 1346 may be combined with the MOD field 1342 to dictate an addressing mode in some examples.

The SIB byte 1304 includes a scale field 1352, an index field 1354, and a base field 1356 to be used in the generation of an address. The scale field 1352 indicates scaling factor. The index field 1354 specifies an index register to use. In some examples, the index field 1354 is supplemented with an additional bit from a prefix (e.g., prefix 1201) to allow for greater addressing. The base field 1356 specifies a base register to use. In some examples, the base field 1356 is supplemented with an additional bit from a prefix (e.g., prefix 1201) to allow for greater addressing. In practice, the content of the scale field 1352 allows for the scaling of the content of the index field 1354 for memory address generation (e.g., for address generation that uses 2scale*index+base).

Some addressing forms utilize a displacement value to generate a memory address. For example, a memory address may be generated according to 2scale*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, a displacement 1207 provides this value. Additionally, in some examples, a displacement factor usage is encoded in the MOD field of the addressing field 1205 that indicates a compressed displacement scheme for which a displacement value is calculated and stored in the displacement field 1207.

In some examples, an immediate field 1209 specifies an immediate value for the instruction. An immediate value may be encoded as a 1-byte value, a 2-byte value, a 4-byte value, etc.

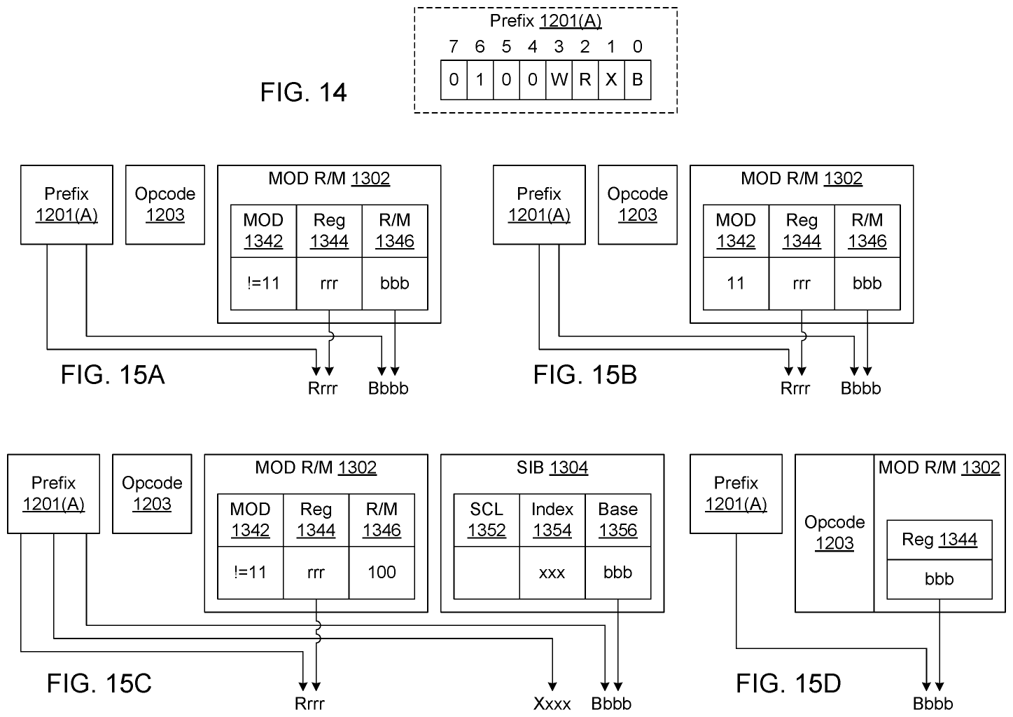

FIG. 14 illustrates examples of a first prefix 1201(A). In some examples, the first prefix 1201(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1201(A) may specify up to three registers using 3-bit fields depending on the format: 1) using the reg field 1344 and the R/M field 1346 of the Mod R/M byte 1302; 2) using the Mod R/M byte 1302 with the SIB byte 1304 including using the reg field 1344 and the base field 1356 and index field 1354; or 3) using the register field of an opcode.

In the first prefix 1201(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (24) registers to be addressed, whereas the MOD R/M reg field 1344 and MOD R/M R/M field 1346 alone can each only address 8 registers.

In the first prefix 1201(A), bit position 2 (R) may be an extension of the MOD R/M reg field 1344 and may be used to modify the ModR/M reg field 1344 when that field encodes a general-purpose register, a 64-bit packed data register (e.g., a SSE register), or a control or debug register. R is ignored when Mod R/M byte 1302 specifies other registers or defines an extended opcode.

Bit position 1 (X) may modify the SIB byte index field 1354.

Bit position 0 (B) may modify the base in the Mod R/M R/M field 1346 or the SIB byte base field 1356; or it may modify the opcode register field used for accessing general purpose registers (e.g., general purpose registers 1125).

FIGS. 15A-D illustrate examples of how the R, X, and B fields of the first prefix 1201(A) are used. FIG. 15A illustrates R and B from the first prefix 1201(A) being used to extend the reg field 1344 and R/M field 1346 of the MOD R/M byte 1302 when the SIB byte 13 04 is not used for memory addressing. FIG. 15B illustrates R and B from the first prefix 1201(A) being used to extend the reg field 1344 and R/M field 1346 of the MOD R/M byte 1302 when the SIB byte 13 04 is not used (register-register addressing). FIG. 15C illustrates R, X, and B from the first prefix 1201(A) being used to extend the reg field 1344 of the MOD R/M byte 1302 and the index field 1354 and base field 1356 when the SIB byte 13 04 being used for memory addressing. FIG. 15D illustrates B from the first prefix 1201(A) being used to extend the reg field 1344 of the MOD R/M byte 1302 when a register is encoded in the opcode 1203.

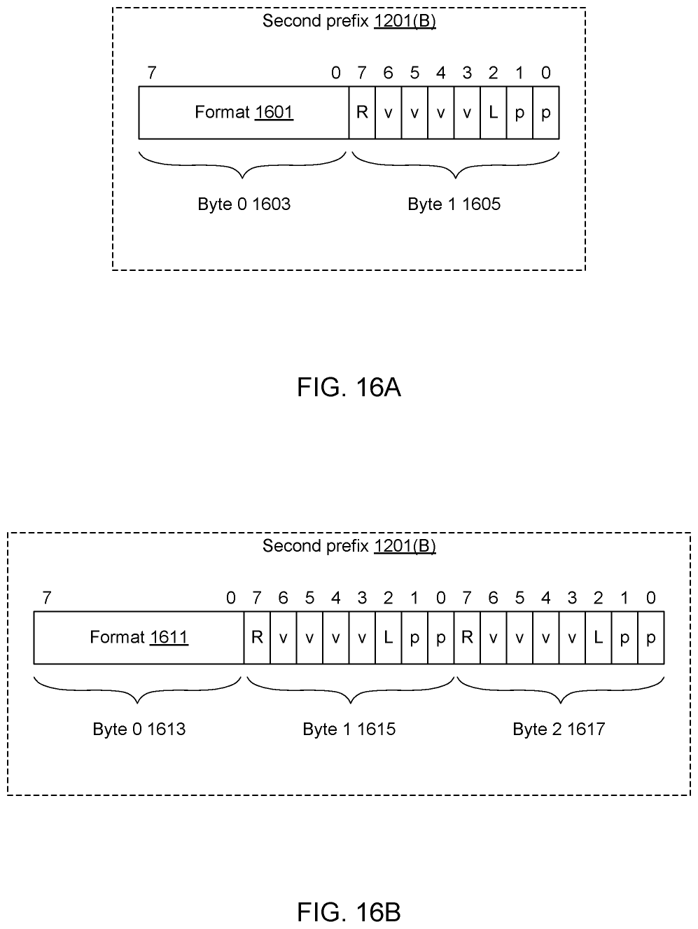

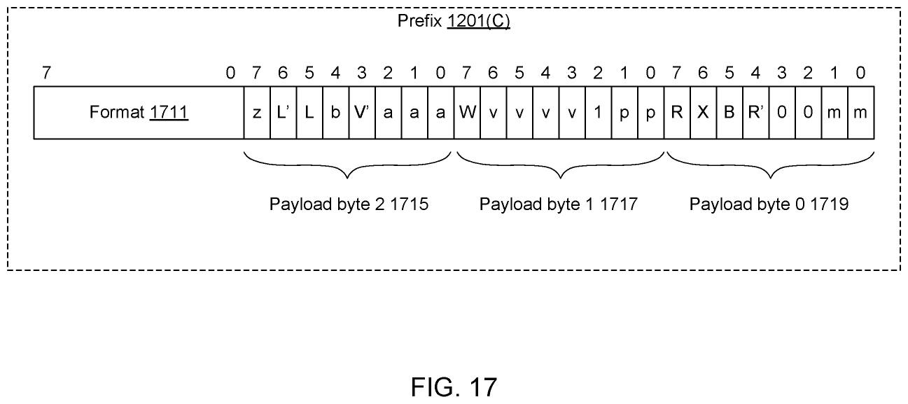

FIGS. 16A-B illustrate examples of a second prefix 1201(B). In some examples, the second prefix 1201(B) is an example of a VEX prefix. The second prefix 1201(B) encoding allows instructions to have more than two operands, and allows SIMD vector registers (e.g., vector/SIMD registers 1110) to be longer than 64-bits (e.g., 128-bit and 256-bit). The use of the second prefix 1201(B) provides for three-operand (or more) syntax. For example, previous two-operand instructions performed operations such as A=A+B, which overwrites a source operand. The use of the second prefix 1201(B) enables operands to perform nondestructive operations such as A=B+C.

In some examples, the second prefix 1201(B) comes in two forms—a two-byte form and a three-byte form. The two-byte second prefix 1201(B) is used mainly for 128-bit, scalar, and some 256-bit instructions; while the three-byte second prefix 1201(B) provides a compact replacement of the first prefix 1201(A) and 3-byte opcode instructions.

FIG. 16A illustrates examples of a two-byte form of the second prefix 1201(B). In one example, a format field 1601 (byte 0 1603) contains the value C5H. In one example, byte 1 1605 includes a “R” value in bit[7]. This value is the complement of the “R” value of the first prefix 1201(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (is complement) form and valid for instructions with 2 or more source operands; 2) encode the destination register operand, specified in 1 s complement form for certain vector shifts; or 3) not encode any operand, the field is reserved and should contain a certain value, such as 1111b.

Instructions that use this prefix may use the Mod R/M R/M field 1346 to encode the instruction operand that references a memory address or encode either the destination register operand or a source register operand.

Instructions that use this prefix may use the Mod R/M reg field 1344 to encode either the destination register operand or a source register operand, be treated as an opcode extension and not used to encode any instruction operand.

For instruction syntax that support four operands, vvvv, the Mod R/M R/M field 1346 and the Mod R/M reg field 1344 encode three of the four operands. Bits[7:4] of the immediate 1209 are then used to encode the third source register operand.

FIG. 16B illustrates examples of a three-byte form of the second prefix 1201(B). In one example, a format field 1611 (byte 0 1613) contains the value C4H. Byte 1 1615 includes in bits[7:5] “R,” “X,” and “B” which are the complements of the same values of the first prefix 1201(A). Bits[4:0] of byte 1 1615 (shown as mmmmm) include content to encode, as need, one or more implied leading opcode bytes. For example, 00001 implies a OFH leading opcode, 00010 implies a 0F38H leading opcode, 00011 implies a leading OF3AH opcode, etc.

Bit[7] of byte 2 1617 is used similar to W of the first prefix 1201(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (is complement) form and valid for instructions with 2 or more source operands; 2) encode the destination register operand, specified in is complement form for certain vector shifts; or 3) not encode any operand, the field is reserved and should contain a certain value, such as 1111b.

Instructions that use this prefix may use the Mod R/M R/M field 1346 to encode the instruction operand that references a memory address or encode either the destination register operand or a source register operand.

Instructions that use this prefix may use the Mod R/M reg field 1344 to encode either the destination register operand or a source register operand, be treated as an opcode extension and not used to encode any instruction operand.

For instruction syntax that support four operands, vvvv, the Mod R/M R/M field 1346, and the Mod R/M reg field 1344 encode three of the four operands. Bits[7:4] of the immediate 1209 are then used to encode the third source register operand.

FIG. 17 illustrates examples of a third prefix 1201(C). In some examples, the first prefix 1201(A) is an example of an EVEX prefix. The third prefix 1201(C) is a four-byte prefix.

The third prefix 1201(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 11) or predication utilize this prefix. Opmask register allow for conditional processing or selection control. Opmask instructions, whose source/destination operands are opmask registers and treat the content of an opmask register as a single value, are encoded using the second prefix 1201(B).

The third prefix 1201(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1201(C) is a format field 1711 that has a value, in one example, of 62H. Subsequent bytes are referred to as payload bytes 1715-1719 and collectively form a 24-bit value of P[23:0] providing specific capability in the form of one or more fields (detailed herein).

In some examples, P[1:0] of payload byte 1719 are identical to the low two mmmmm bits. P[3:2] are reserved in some examples. Bit P[4] (R′) allows access to the high 16 vector register set when combined with P[7] and the ModR/M reg field 1344. P[6] can also provide access to a high 16 vector register when SIB-type addressing is not needed. P[7:5] consist of an R, X, and B which are operand specifier modifier bits for vector register, general purpose register, memory addressing and allow access to the next set of 8 registers beyond the low 8 registers when combined with the ModR/M register field 1344 and ModR/M R/M field 1346. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in is complement form for certain vector shifts; or 3) not encode any operand, the field is reserved and should contain a certain value, such as 1111b.

P[15] is similar to W of the first prefix 1201(A) and second prefix 1211(B) and may serve as an opcode extension bit or operand size promotion.

P[18:16] specify the index of a register in the opmask (writemask) registers (e.g., writemask/predicate registers 1115). In one example, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Exemplary examples of encoding of registers in instructions using the third prefix 1201(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | ModR/M | GPR, Vector | Destination or Source |
| | | | reg | | |
| VVVV | V′ | vvvv | | GPR, Vector | 2nd Source or Destination |
| RM | X | B | ModR/M | GPR, Vector | 1st Source or Destination |
| | | | R/M | | |
| BASE | 0 | B | ModR/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | ModR/M reg | GPR, Vector | Destination or Source |
| VVVV | vvvv | GPR, Vector | 2nd Source or Destination |
| RM | ModR/M R/M | GPR, Vector | 1st Source or Destination |
| BASE | ModR/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | ModR/M Reg | k0-k7 | Source |
| VVVV | vvvv | k0-k7 | 2nd Source |
| RM | ModR/M R/M | k0-k7 | 1st Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

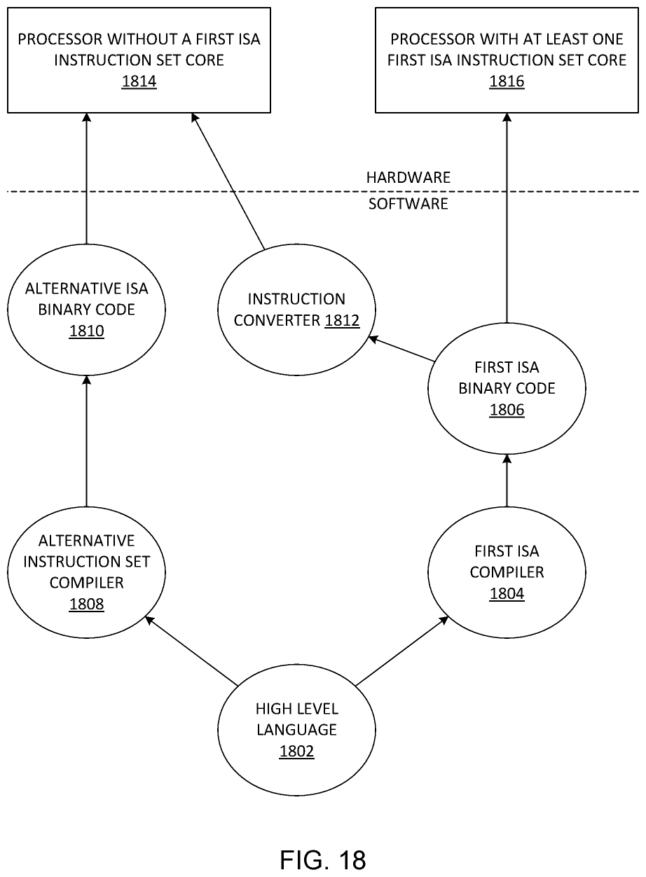

FIG. 18 illustrates a block diagram contrasting the use of a software instruction converter to convert binary instructions in a source instruction set architecture to binary instructions in a target instruction set architecture according to examples. In the illustrated example, the instruction converter is a software instruction converter, although alternatively the instruction converter may be implemented in software, firmware, hardware, or various combinations thereof. FIG. 18 shows a program in a high-level language 1802 may be compiled using a first ISA compiler 1804 to generate first ISA binary code 1806 that may be natively executed by a processor with at least one first instruction set architecture core 1816. The processor with at least one first ISA instruction set architecture core 1816 represents any processor that can perform substantially the same functions as an Intel® processor with at least one first ISA instruction set architecture core by compatibly executing or otherwise processing (1) a substantial portion of the instruction set architecture of the first ISA instruction set architecture core or (2) object code versions of applications or other software targeted to run on an Intel processor with at least one first ISA instruction set architecture core, in order to achieve substantially the same result as a processor with at least one first ISA instruction set architecture core. The first ISA compiler 1804 represents a compiler that is operable to generate first ISA binary code 1806 (e.g., object code) that can, with or without additional linkage processing, be executed on the processor with at least one first ISA instruction set architecture core 1816. Similarly, FIG. 18 shows the program in the high-level language 1802 may be compiled using an alternative instruction set architecture compiler 1808 to generate alternative instruction set architecture binary code 1810 that may be natively executed by a processor without a first ISA instruction set architecture core 1814. The instruction converter 1812 is used to convert the first ISA binary code 1806 into code that may be natively executed by the processor without a first ISA instruction set architecture core 1814. This converted code is not necessarily to be the same as the alternative instruction set architecture binary code 1810; however, the converted code will accomplish the general operation and be made up of instructions from the alternative instruction set architecture. Thus, the instruction converter 1812 represents software, firmware, hardware, or a combination thereof that, through emulation, simulation or any other process, allows a processor or other electronic device that does not have a first ISA instruction set architecture processor or core to execute the first ISA binary code 1806.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Numerous details are described herein to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

In one or more first embodiments, a processor comprises an instruction fetch unit comprising circuitry to receive a pointer to an instruction of an instruction sequence, based on the pointer, identify a page table as comprising an entry which corresponds to the instruction, and access metadata associated with the page table, the metadata comprising an identifier of an operational mode of the processor, and a mode selector unit coupled to receive the identifier of the operational mode from the instruction fetch unit, the mode selector unit comprising circuitry to perform a transition of the processor to the operational mode based on the identifier, and an execution unit coupled to the mode selector unit, the execution unit to execute the instruction based on the operational mode.

In one or more second embodiments, further to the first embodiment, the mode selector unit is to perform the transition independent of any explicit identification of the operational mode by the instruction sequence.

In one or more third embodiments, further to the first embodiment or the second embodiment, the mode selector unit to perform the transition comprises the mode selector unit to transition the processor between a first operational mode and a second operational mode, wherein the first operational mode corresponds to a first instruction set architecture (ISA), and wherein the second operational mode corresponds to a second ISA.

In one or more fourth embodiments, further to any of the first through third embodiments, the mode selector unit to perform the transition comprises the mode selector unit to transition the processor between a first operational mode and a second operational mode, wherein the first operational mode is to provide a first level of a power performance parameter, wherein the second operational mode is to provide a second level of the power performance parameter.

In one or more fifth embodiments, further to the fourth embodiment, the power performance parameter comprises a supply voltage parameter, or a clock frequency parameter.

In one or more sixth embodiments, further to any of the first through third embodiments, the mode selector unit to perform the transition comprises the mode selector unit to transition the processor between a first operational mode and a second operational mode, wherein the first operational mode enables a security feature, and wherein the second operational mode disables the security feature.

In one or more seventh embodiments, further to the sixth embodiment, the security feature comprises a speculative execution control.

In one or more eighth embodiments, further to any of the first through third embodiments, the metadata is to be accessed by the instruction fetch unit at a mode register of the processor.

In one or more ninth embodiments, further to any of the first through third embodiments, the metadata, the pointer, the instruction, the entry, the page table, and the operational mode are, respectively, first metadata, a first pointer, a first instruction, a first entry, a first page table, and a first operational mode, and wherein the instruction fetch unit is further to receive a second pointer to a second instruction of the instruction sequence, wherein, based on the second pointer, the instruction fetch unit is further to identify a second page table as comprising a second entry which corresponds to the second instruction, and access second metadata of the second page table to determine a second operational mode of the processor, wherein the mode selector unit is further to perform another transition of the processor to the second operational mode based on the second metadata, and wherein the execution unit is further to execute the second instruction based on the second operational mode.

In one or more tenth embodiments, one or more non-transitory computer-readable storage media having stored thereon instructions which, when executed by one or more processing units, cause the one or more processing units to perform a method comprising receiving a pointer to an instruction of an instruction sequence, based on the pointer identifying a page table as comprising an entry which corresponds to the instruction, accessing metadata associated with the page table, the metadata comprising an identifier of an operational mode of a processor, and performing a transition of the processor to the operational mode based on the identifier, and executing the instruction based on the operational mode.

In one or more eleventh embodiments, further to the tenth embodiment, the transition is performed independent of any explicit identification of the operational mode by the instruction sequence.

In one or more twelfth embodiments, further to the tenth embodiment or the eleventh embodiment, performing the transition comprises transitioning the processor between a first operational mode and a second operational mode, wherein the first operational mode corresponds to a first instruction set architecture (ISA), and wherein the second operational mode corresponds to a second ISA.

In one or more thirteenth embodiments, further to any of the tenth through twelfth embodiments, performing the transition comprises transitioning the processor between a first operational mode and a second operational mode, wherein the first operational mode is to provide a first level of a power performance parameter, wherein the second operational mode is to provide a second level of the power performance parameter.

In one or more fourteenth embodiments, further to the thirteenth embodiment, the power performance parameter comprises a supply voltage parameter, or a clock frequency parameter.

In one or more fifteenth embodiments, further to any of the tenth through twelfth embodiments, performing the transition comprises transitioning the processor between a first operational mode and a second operational mode, wherein the first operational mode enables a security feature, and wherein the second operational mode disables the security feature.

In one or more sixteenth embodiments, further to the fifteenth embodiment, the security feature comprises a speculative execution control.

In one or more seventeenth embodiments, further to any of the tenth through twelfth embodiments, the metadata is accessed at a mode register of the processor.

In one or more eighteenth embodiments, further to any of the tenth through twelfth embodiments, the metadata, the pointer, the instruction, the entry, the page table, and the operational mode are, respectively, first metadata, a first pointer, a first instruction, a first entry, a first page table, and a first operational mode, and wherein the method further comprises receiving a second pointer to a second instruction of the instruction sequence, based on the second pointer identifying a second page table as comprising a second entry which corresponds to the second instruction, accessing second metadata of the second page table to determine a second operational mode of the processor, and performing another transition of the processor to the second operational mode based on the second metadata, and executing the second instruction based on the second operational mode.

In one or more nineteenth embodiments, a system comprises a memory to store multiple instructions which are to be executed in a sequence, a processor coupled to the memory, the processor comprising an instruction fetch unit comprising circuitry to receive a pointer to an instruction of the multiple instructions, based on the pointer, identify the page table as comprising an entry which corresponds to the instruction, and access metadata associated with the page table, the metadata comprising an identifier of an operational mode of the processor, and a mode selector unit coupled to receive the identifier of the operational mode from the instruction fetch unit, the mode selector unit comprising circuitry to perform a transition of the processor to the operational mode based on the identifier, and an execution unit coupled to the mode selector unit, the execution unit to execute the instruction based on the operational mode.

In one or more twentieth embodiments, further to the nineteenth embodiment, the mode selector unit is to perform the transition independent of any explicit identification of the operational mode by the sequence.

In one or more twenty-first embodiments, further to the nineteenth embodiment or the twentieth embodiment, the mode selector unit to perform the transition comprises the mode selector unit to transition the processor between a first operational mode and a second operational mode, wherein the first operational mode corresponds to a first instruction set architecture (ISA), and wherein the second operational mode corresponds to a second ISA.

In one or more twenty-second embodiments, further to any of the nineteenth through twenty-first embodiments, the mode selector unit to perform the transition comprises the mode selector unit to transition the processor between a first operational mode and a second operational mode, wherein the first operational mode is to provide a first level of a power performance parameter, wherein the second operational mode is to provide a second level of the power performance parameter.

In one or more twenty-third embodiments, further to the twenty-second embodiment, the power performance parameter comprises a supply voltage parameter, or a clock frequency parameter.

In one or more twenty-fourth embodiments, further to any of the nineteenth through twenty-first embodiments, the mode selector unit to perform the transition comprises the mode selector unit to transition the processor between a first operational mode and a second operational mode, wherein the first operational mode enables a security feature, and wherein the second operational mode disables the security feature.

In one or more twenty-fifth embodiments, further to the twenty-fourth embodiment, the security feature comprises a speculative execution control.

In one or more twenty-sixth embodiments, further to any of the nineteenth through twenty-first embodiments, the metadata is to be accessed by the instruction fetch unit at a mode register of the processor.

In one or more twenty-seventh embodiments, further to any of the nineteenth through twenty-first embodiments, the metadata, the pointer, the instruction, the entry, the page table, and the operational mode are, respectively, first metadata, a first pointer, a first instruction, a first entry, a first page table, and a first operational mode, and wherein the instruction fetch unit is further to receive a second pointer to a second instruction of the multiple instructions, wherein, based on the second pointer, the instruction fetch unit is further to identify a second page table as comprising a second entry which corresponds to the second instruction, and access second metadata of the second page table to determine a second operational mode of the processor, wherein the mode selector unit is further to perform another transition of the processor to the second operational mode based on the second metadata, and wherein the execution unit is further to execute the second instruction based on the second operational mode.

Techniques and architectures for determining an execution mode of a processor are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A processor comprising:
an instruction fetch unit comprising circuitry to:
receive a pointer to an instruction of an instruction sequence;
based on the pointer, identify a page table as comprising an entry which corresponds to the instruction; and
access metadata associated with the page table, the metadata comprising an identifier of an operational mode of the processor; and
a mode selector unit coupled to receive the identifier of the operational mode from the instruction fetch unit, the mode selector unit comprising circuitry to perform a transition of the processor to the operational mode based on the identifier; and
an execution unit coupled to the mode selector unit, the execution unit to execute the instruction based on the operational mode.

2. The processor of claim 1, wherein the mode selector unit is to perform the transition independent of any explicit identification of the operational mode by the instruction sequence.

3. The processor of claim 1, wherein the mode selector unit to perform the transition comprises the mode selector unit to transition the processor between a first operational mode and a second operational mode, wherein the first operational mode corresponds to a first instruction set architecture (ISA), and wherein the second operational mode corresponds to a second ISA.

4. The processor of claim 1, wherein the mode selector unit to perform the transition comprises the mode selector unit to transition the processor between a first operational mode and a second operational mode, wherein the first operational mode is to provide a first level of a power performance parameter, wherein the second operational mode is to provide a second level of the power performance parameter.

5. The processor of claim 4, wherein the power performance parameter comprises a supply voltage parameter, or a clock frequency parameter.

6. The processor of claim 1, wherein the mode selector unit to perform the transition comprises the mode selector unit to transition the processor between a first operational mode and a second operational mode, wherein the first operational mode enables a security feature, and wherein the second operational mode disables the security feature.

7. The processor of claim 8, wherein the security feature comprises a speculative execution control.

8. The processor of claim 1, wherein the metadata is to be accessed by the instruction fetch unit at a mode register of the processor.

9. The processor of claim 1, wherein the metadata, the pointer, the instruction, the entry, the page table, and the operational mode are, respectively, first metadata, a first pointer, a first instruction, a first entry, a first page table, and a first operational mode; and
wherein the instruction fetch unit is further to receive a second pointer to a second instruction of the instruction sequence;
wherein, based on the second pointer, the instruction fetch unit is further to:
identify a second page table as comprising a second entry which corresponds to the second instruction; and
access second metadata of the second page table to determine a second operational mode of the processor;
wherein the mode selector unit is further to perform another transition of the processor to the second operational mode based on the second metadata; and
wherein the execution unit is further to execute the second instruction based on the second operational mode.

10. One or more non-transitory computer-readable storage media having stored thereon instructions which, when executed by one or more processing units, cause the one or more processing units to perform a method comprising:
receiving a pointer to an instruction of an instruction sequence;
based on the pointer:
identifying a page table as comprising an entry which corresponds to the instruction;
accessing metadata associated with the page table, the metadata comprising an identifier of an operational mode of a processor; and
performing a transition of the processor to the operational mode based on the identifier; and
executing the instruction based on the operational mode.

11. The one or more computer-readable storage media of claim 10, wherein the transition is performed independent of any explicit identification of the operational mode by the instruction sequence.

12. The one or more computer-readable storage media of claim 10, wherein performing the transition comprises transitioning the processor between a first operational mode and a second operational mode, wherein the first operational mode corresponds to a first instruction set architecture (ISA), and wherein the second operational mode corresponds to a second ISA.

13. The one or more computer-readable storage media of claim 10, wherein performing the transition comprises transitioning the processor between a first operational mode and a second operational mode, wherein the first operational mode is to provide a first level of a power performance parameter, wherein the second operational mode is to provide a second level of the power performance parameter.

14. The one or more computer-readable storage media of claim 10, wherein performing the transition comprises transitioning the processor between a first operational mode and a second operational mode, wherein the first operational mode enables a security feature, and wherein the second operational mode disables the security feature.

15. The one or more computer-readable storage media of claim 10, wherein the metadata is accessed at a mode register of the processor.

16. A system comprising:
a memory to store multiple instructions which are to be executed in a sequence;
a processor coupled to the memory, the processor comprising:
an instruction fetch unit comprising circuitry to:
receive a pointer to an instruction of the multiple instructions;
based on the pointer, identify the page table as comprising an entry which corresponds to the instruction; and
access metadata associated with the page table, the metadata comprising an identifier of an operational mode of the processor; and
a mode selector unit coupled to receive the identifier of the operational mode from the instruction fetch unit, the mode selector unit comprising circuitry to perform a transition of the processor to the operational mode based on the identifier; and
an execution unit coupled to the mode selector unit, the execution unit to execute the instruction based on the operational mode.

17. The system of claim 16, wherein the mode selector unit is to perform the transition independent of any explicit identification of the operational mode by the sequence.

18. The system of claim 16, wherein the mode selector unit to perform the transition comprises the mode selector unit to transition the processor between a first operational mode and a second operational mode, wherein the first operational mode corresponds to a first instruction set architecture (ISA), and wherein the second operational mode corresponds to a second ISA.

19. The system of claim 16, wherein the mode selector unit to perform the transition comprises the mode selector unit to transition the processor between a first operational mode and a second operational mode, wherein the first operational mode is to provide a first level of a power performance parameter, wherein the second operational mode is to provide a second level of the power performance parameter.

20. The system of claim 16, wherein the mode selector unit to perform the transition comprises the mode selector unit to transition the processor between a first operational mode and a second operational mode, wherein the first operational mode enables a security feature, and wherein the second operational mode disables the security feature.
